(19) United States
(12) Patent Application Publication
(10) Pub. No.: US 2024/0402488 A1
(43) Pub. Date: Dec. 5, 2024

(54) DEEP LEARNING DRIVEN ADAPTIVE OPTICS FOR SINGLE MOLECULE LOCALIZATION MICROSCOPY

(71) Applicant: Purdue Research Foundation, West Lafayette, IN (US)

(72) Inventors: Fang Huang, West Lafayette, IN (US); Peiyi Zhang, West Lafayette, IN (US)

(21) Appl. No.: 18/678,100

(22) Filed: May 30, 2024

Related U.S. Application Data
(60) Provisional application No. 63/469,610, filed on May 30, 2023.

(51) Int. Cl. G02B 27/00; G01N 21/64; G02B 21/16; G02B 21/36; G02B 26/08; G06T 5/20; G06T 5/60; G06T 5/80; G06T 7/00; G06T 7/11

(52) U.S. Cl. CPC G02B 27/0025; G02B 21/16; G02B 21/365; G02B 26/0825; G06T 5/20; G06T 5/60; G06T 5/80; G06T 7/0014; G06T 7/11; G01N 2021/6439; G06T 2207/10056; G06T 2207/20081; G06T 2207/20084; G06T 2207/30024

(57) ABSTRACT

The invention generally relates to systems and method for deep learning driven adaptive optics for single molecule localization microscopy. In certain aspects, the invention provides a system comprising: an imaging apparatus configured for conducting single-molecule localization microscopy (SMLM), wherein the imaging apparatus comprises a deformable mirror and a dynamic filter; and a processor operably associated with the imaging apparatus. In certain embodiments, the processor is configured to: monitor individual emission patterns produced via the imaging apparatus from a plurality of different single molecules in a sample; infer shared wavefront distortion for each of the individual emission patterns; provide the shared wavefront distortion for each of the individual emission patterns through the dynamic filter; and operate the deformable mirror to compensate for sample induced aberrations.

### RELATED APPLICATION

The present application claims the benefit of and priority to U.S. provisional patent application Ser. No. 63/469,610, filed May 30, 2023, the content of which is incorporated by reference herein in its entirety.

### FIELD OF THE INVENTION

The invention generally relates to systems and method for deep learning driven adaptive optics for single molecule localization microscopy.

### BACKGROUND

Fluorescent microscopy is an indispensable tool in visualizing cellular and tissue machinery with molecular specificity, however, its resolution is limited to 250-700 nm laterally and axially due to the diffraction of light. Molecular features smaller than this limit cannot be resolved. Super resolution microscopies such as Stimulated Emission Depletion Microscopy (STED), Structured Illumination Microscopy (SIM)3, and Single Molecule Localization Microscopy (SMLM) have overcome this barrier, allowing biological observations well beyond this fundamental limit of light. In particular, SMLM detects isolated photo-switchable or convertible fluorescent dyes or proteins, pinpoints the centers of individual probes from their emission patterns, and reconstructs the molecular centers into a super-resolution image. Localization precision as low as 1-10 nm can be achieved in fixed and living cells.

SMLM in tissues, however, is challenging. One major reason is the distortion and blurring of single molecule emission patterns (i.e. PSFs) caused by the inhomogeneous refractive indices within the tissue. Such alteration often reduces the information content12 carried by each detected photon, increases localization uncertainty, and thus causes significant resolution loss, which is irreversible by post-processing13. Reversing these sample induced aberrations requires optical path modifications in a microscopy system, commonly with a deformable mirror or a spatial light modulator, responsive towards each specimen and field-of-view to adaptively restore the PSFs of single emitters, and thus the achievable resolution. This process is known as adaptive optics (AO).

Guiding a deformable mirror to compensate sample induced aberrations, the distorted wavefront needs to be measured. For point-scanning microscopes, such as confocal and two-photon, the detection focus serves as a ‘guide star’ providing a stable wavefront measurable both directly and indirectly. In contrast, wavefronts of single molecule emissions, in spite of their abundance in SMLM experiments, cannot be directly measured as the signals from individual molecules blink stochastically with limited photons. Besides, wavefronts passing through the system are composed of not only the aberrated wavefront induced by the specimen, but also the wavefront variations induced by lateral and axial positions from a collection of emitters in a volume. For this reason, current sensorless AO-SMLM developments focus on iteratively introducing mirror changes then evaluating the changes with image-quality metrics. Despite that these iterative methods require a large number of cycles, each including image acquisition and mirror changes, to reach the optimal correction, these approaches provide robust corrections for tissue induced aberrations only when the target tissue structures are planar or with small axial extent. This is because emission patterns from single molecules at different axial positions results in inconsistent, and, in some cases, even opposite metric responses and thus fundamentally limit the efficacy of these approaches for aberration correction in tissues.

### SUMMARY

Bypassing the previous iterative trial-then-evaluate processes, the invention herein provides new systems and methods based on deep learning driven adaptive optics for SMLM to allow direct inference of wavefront distortion and near real time compensation. The systems and methods herein make use of a trained deep neural network (DNN) that monitors the individual emission patterns from single molecule experiments, infers their shared wavefront distortion, feeds the estimates through a dynamic filter (Kalman), and drives a deformable mirror to compensate sample induced aberrations. The method, referred to as deep learning driven adaptive optics (DL-AO) for single molecule imaging, simultaneously estimates and compensates 28 types of wavefront deformation shapes, restores single molecule emission patterns approaching the conditions untouched by specimen, and improves the resolution and fidelity of 3D SMLM through thick tissue specimens over 130 micrometer, with as few as 3-20 mirror changes.

In certain aspects, the invention provides a system comprising: an imaging apparatus configured for conducting single-molecule localization microscopy (SMLM), wherein the imaging apparatus comprises a deformable mirror and a dynamic filter (such as a Kalman filter); and a processor operably associated with the imaging apparatus and configured to: monitor individual emission patterns produced via the imaging apparatus from a plurality of different single molecules in a sample; infer shared wavefront distortion for each of the individual emission patterns; provide the shared wavefront distortion for each of the individual emission patterns through the dynamic filter; and operate the deformable mirror to compensate for sample induced aberrations.

In other aspects, the invention provides a method for improving single-molecule localization microscopy (SMLM), the method comprising: monitor, via a processor operably associated with an imaging apparatus configured for conducting single-molecule localization microscopy (SMLM), individual emission patterns produced via the imaging apparatus from a plurality of different single molecules in a sample; inferring, via the processor, shared wavefront distortion for each of the individual emission patterns; providing, via the processor, the shared wavefront distortion for each of the individual emission patterns through a dynamic filter of the imaging apparatus; and operating, via the processor, a deformable mirror of the imaging apparatus to compensate for sample induced aberrations, thereby improving SMLM.

In certain embodiments of the systems and methods, the processor simultaneously estimates and compensates for 28 types of wavefront deformation shapes. In certain embodiments of the systems and methods, the processor restores single molecule emission patterns approaching pre-analysis conditions. In certain embodiments of the systems and methods, the processor improves resolution and fidelity of three dimensional SMLM through tissue specimens over 130 micrometers. In certain embodiments of the systems and methods, the improvement is accomplished in as few as 3-20 mirror changes.

In certain embodiments of the systems and methods, the processor is trained via a training data set, wherein the training data set that comprises segmenting single molecule-containing sub-regions. In certain embodiments of the systems and methods, each sub-region goes through a sequence of template matching processes, which are organized as convolutional layers and residual blocks with PReLU activations and batch normalizations in between. In certain embodiments of the systems and methods, the processor then fully connects through 1×1 convolutional layers to an output vector of values amplitude estimates for wavefront shapes in terms of the native mirror deformation modes. In certain embodiments of the systems and methods, the wavefront is represented with coefficients of orthogonal basis.

### BRIEF DESCRIPTION OF THE DRAWINGS

FIG. 1 shows deep learning driven adaptive optics for single molecule localization microscopy. Upon the acquisition of camera frames, detected single molecule emission patterns from stochastic lateral and axial positions are isolated and sent to a trained deep neural network. The network outputs a vector of mirror deformation-mode amplitudes, for each biplane detection of single molecule. The estimations pre-/post- each compensation are then combined through Kalman filter to drive the next deformable mirror update. ‘p’ and ‘q’ represent numbers of feature maps input and output to a residue block (the orange box). ‘N’ represents the image width/height. ‘s’ is stride size in a convolutional layer.

FIG. 2 Panels A-H show performance characterization of DL-AO. (Panel A) Measurement and feedback flow for deformable mirror updates driven by deep neural network. Sub-regions are enlarged to show examples of PSF shapes from blinking molecules. (Panel B) An example of PSFs, pupil phases and mirror mode coefficients before and after DL-AO, when compensating artificially induced aberrations. Compensations are performed in real time during SMLM experiments. PSFs are measured from 100-nm-diameter crimson beads nearby the compensation area post SMLM acquisition. (Panel C) Comparison between DL-AO and metric-based AO on compensating sample induced distortion at bottom coverslip surface including PSF shapes and raw single molecule blinking frames. (Panel D) Comparison between DL-AO and metric-based AO on compensating sample induced distortion at 134 μm from bottom coverslip surface in water-based media (n=1.35) including PSF shapes and raw single molecule blinking frames. (Panel E) Summary of repeated tests of DL-AO for compensating aberrations of different levels (in Wᵣₘₛ) based on simulated SMLM blinking data. Each simulated SMLM frames contain 128×128 pixels, with pixel size of 119 nm. Number of PSFs per frame were generated from Poisson distribution with a mean of 13. Axial positions of molecules were generated from uniform distribution from −1 to 1 μm range. The number of photon counts in each PSF was generated from exponential distribution with mean equal to 2500. The background photon counts in each frame was set to be 10. (Panel F) Summary of repeated tests of DL-AO for compensating aberrations in different levels (in Wᵣₘₛ) based on experimental blinking frames from immune-fluorescence-labeled Tom20 specimen. (Panel G) Quantitative comparisons between PSFs measured under instrument optimum and those measured after DL-AO and metric-based AO using 3D normalized cross correlation (NCC). IMM stands for index mismatched specimens at 134 μm with refractive indices of sample media and immersion oil being 1.35 and 1.406 respectively measured by Abbe refractometer (334610, Thermo Scientific). The labels for x axis with ‘i-j’ format denote j^{th} repeated tests for compensation at area i. (Panel H) DL-AO compensates for random and sudden wavefront changes during continuous SMLM acquisition. Images in the top row are the distorted wavefronts introduced during continuous imaging. A dot with a blue circle corresponds to a mirror update that introduces a random wavefront distortion (targeted level of 0.75 rad in Wᵣₘₛ). Each grey arrow points from an induced wavefront distortion to its corresponding mirror update. The dots without blue circles correspond to mirror updates driven by deep neural network. The single molecule blinking frames with random and sudden wavefront changes were continuously acquired for three minutes from the immune fluorescence-labeled Tom20 specimen. Scale bars in Panels B-D and G are 3 μm.

FIG. 3 Panels A-K show demonstrations of DL-AO correcting index mismatch induced aberration by imaging Tom20 proteins in COS-7 cells through 134 μm water-based imaging media (Panel A) 3D SMLM reconstruction of Tom20 imaged through 134 μm water-based media without AO, then reconstructed with in situ PSF model (INSPR). (Panel B) 3D SMLM reconstruction of Tom20 imaged through 134 μm water-based media with DL-AO, then reconstructed with INSPR. (Panel C) Axial cross-section of region in Panels A and B compared without and with DL-AO. (Panel D) Enlarged regions in Panels A and B comparing cases without and with DL-AO. (E) 3D SMLM reconstruction of Tom20 imaged through 134 μm water-based media with DL-AO, then reconstructed with INSPR. (Panel F) Axial cross-sections in A and B comparing cases without and with DL-AO combined with reconstruction methods of either in vitro PSF model (PR) or in situ PSF models (INSPR). The PR PSF model for no AO case was obtained from 100-nm-diameter crimson bead (referred to as bead hereafter) next to the imaged area. The in vitro model for DL-AO was obtained from beads at bottom coverslip surface. (Panel G) Enlarged regions in A and B comparing cases without and with DL-AO combined with reconstruction methods of either in vitro PR or INSPR. (Panel H) Cartoon of the constructed Tom20 specimen and visualization of pupil retrieved from beads at top (No AO and DL-AO) and bottom (optimum) coverslip. (Panel I) Raw blinking data (after converting intensity readings in camera frames to approximate photon counts) of Panels A and B compared without and with DL-AO. Scale bar: 10 μm. (Panel J) Comparison of measured PSFs at 134 μm without and with DL-AO, in situ PSF models without and with DL-AO, and the instrument optimum. Scale bar: 2 μm. (Panel K) Fisher information content without and with DL-AO was calculated based on PSF model built from beads nearby the imaged area. The values correspond to PSFs with 1000 total photon counts and 10 background photons per pixel at axial positions of −1.5 μm to 1.5 μm.

FIG. 4 Panels A-F show demonstrations of DL-AO correcting sample induced aberrations by imaging Tom20 proteins in COS-7 cells through 110 μm unlabeled mouse brain section. (Panel A) 3D SMLM reconstruction of Tom20 proteins imaged through unlabeled tissue without AO, reconstructed with in vitro PSF models: theoretical index mismatch model (PR, upper triangle) and in situ PSF models (INSPR, lower triangle). (B) Tom20 imaged through unlabeled tissue with DL-AO, reconstructed with in vitro PSF model (PR, upper triangle) and in situ PSF models (INSPR, lower triangle). (Panel C) Axial cross-sections in Panels A and B comparing cases without and with DL-AO. (Panel D) Zoom-in regions in Panels A and B comparing cases with and without DL-AO. (Panel E) Axial cross-sections along the dashed line in Panels A and B. (Panel F) Comparisons of PSFs and their pupil functions. The theoretical index mismatch model is based on a measured refractive index of 1.35 for sample media, which is measured by Abbe refractometer (334610, Thermo Scientific). Scale bar: 2 μm. Color code in Panels A-E indicates axial positions.

FIG. 5 Panels A-L show 3D reconstruction of immune-fluorescence-labeled amyloid-β fibrils in 125 μm brain sections of 7.5-month-old 5×FAD female mouse. (Panel A) Amyloid-β fibrils imaged using SMLM with DL-AO and reconstructed with in situ PSF model (INSPR) at 85 μm from coverslip surface. Color code indicates axial positions of single molecule localizations. (Panel B) Sub-regions and cross-sections in Panel A showing comparisons of Aβ fibrils imaged without and with DL-AO, reconstructed with either in vitro PSF model (PR) or in situ PSF models (INSPR). (Panel C) Comparison between without and with AO, where without AO data are reconstructed using in vitro PR and AO data used INSPR reconstruction. (Panels D, E) Aβ fibrils imaged with DL-AO and reconstructed with INSPR at 51 μm and 67 μm from coverslip surface. (Panel F) Region in Panel D comparing cases without and with DL-AO. (Panel G) Axial cross-sections in Panel D comparing without and with DL-AO. (Panel H) Regions in Panel E compared cases without and with DL-AO. (Panel I) Axial cross-sections in Panel E comparing cases without and with DL-AO. (Panel J) Measurements of fibril widths in lateral and axial cross-sections in Panels A, D, E. (Panel K) Comparison between intensity profiles along white line in Panel C without and with DL-AO. (Panel L) Comparison between intensity profiles along white line in Panel G without and with DL-AO. ‘norm. I.’ in Panels K and L stands for normalized intensity, where intensity in reconstructed image reflects counts of localized single molecules. The imaged structures were found at depths near the axial limit of tissue thicknesses. Optically measured tissue thicknesses vary among samples, which might be caused by variations in media volume between bottom and top coverslips.

FIG. 6 Panels A-G show dendrites and spines in immune-fluorescence-labeled Thy1-ChR2-EYFP in 150-250 μm cut brain sections of 7-week-old mice. (Panels A, E) Diffraction-limited images of Thy1-ChR2-EYFP. Images in Panels A and E are generated by replacing single molecule localization points in Panels B and F with their corresponding PSFs without aberration. (Panel B) Super-resolution reconstruction of Thy1-ChR2-EYFP using SMLM with DL-AO through a 250-μm cut brain section. (Panels C, F) Super resolution reconstructions of Thy1-ChR2-EYFP using SMLM with DL-AO through 150-μm cut brain sections. (Panel D) Axial cross-sections identified spines in Panels B, C, F. (Panel G) Identified spines in Panels B, C, F, and the corresponding size measurements of their necks and heads. ‘Norm. I.’ stands for normalized intensity, where intensity in reconstructed image reflects counts of localized single molecules. ‘dist.’ stands for distance. The histograms show the raw intensity counts along the lines indicated by white arrows in Panel G. Sizes are measured at the full widths at the half maximum intensity. Color code indicates axial positions. White arrows in Panels A-F point towards identified spines. The imaged structures were found at depths near the axial limit of tissue thicknesses. Optically measured tissue thicknesses vary among samples, which might be caused by variations in media volume between bottom and top coverslips.

FIG. 7A shows simulated emission patterns from single molecules at different axial positions. FIG. 7B shows metric values vs. amplitudes of mirror shapes. Each metric value was calculated through a weighted sum of the Fourier transform of an acquisition under certain mirror shape. The acquisitions were simulated as images with 400×400 pixels and 65 nm pixel size. Each acquisition contains one PSF with 10000 photon counts and 10 background photon counts. Each row shows the changes in metric values when scanning the amplitudes of a mirror shape shown on the left. Different columns show metrics calculated from PSFs at different axial positions. ‘DAst’ and ‘Sph’ stand for Diagonal Astigmatism and Primary Spherical in Zernike polynomials.

FIG. 8 panels A-B show a comparison between PSFs measured under different deformable_mirror voltage maps and PSFs simulated from network estimations. Network estimations were obtained by inputting 31 biplane sub-regions, each of which contains a single PSF measured from 100-nm-diameter crimson bead, then averaging among the 31 outputs. The 31 sub-regions were measured by moving Piezo stage from −1.5 μm to 1.5 μm around the focus of the first detection plane, with 0.1 μm step size. Only PSFs from first detection plane were shown in this figure for comparison. PSFs were simulated without background and noise for visualization. Scale bar: 2 μm. ‘acqui.’ stands for acquisition. ‘net’ stands for network estimation. FIG. 8 panel C shows a quantitative comparisons between measured PSFs under different mirror voltage maps and PSFs simulated from network estimations w.r.t. the measured PSFs. The similarities between measured PSFs and simulated PSFs were quantified using 3D normalized cross correlation (NCC). Acquisition in FIG. 8 panel A has relatively higher signal level comparing to acquisition in FIG. 8 panel B. The NCC values were calculated between PSFs simulated from network estimations (w.r.t. measurements under either higher signal or lower signal) and the PSFs measured under higher signal level as examples shown in FIG. 8 panel A.

FIGS. 9A-C show comparison between measured PSFs and PSFs simulated from network estimations based on a single measurement of an isolated molecule The left column shows measured PSFs from 100-nm-diameter crimson beads when scanning Piezo stage at different axial positions. The measured PSFs in biplane sub-regions were sent to neural network, which outputs a vector of mirror mode coefficients for each sub-region. The measured mirror modes were linear combined with mirror mode coefficients output from network, which result in wavefronts shown in the middle column. The wavefront for network estimations based on all measured PSFs were generated with an averaged value among network outputs w.r.t. PSFs at different axial positions. The wavefront were then used to simulate PSFs at different axial positions to check the similarity between measured PSFs and PSFs simulated from network estimations. PSFs were simulated without background and noise for visualization. Scale bars: 2 μm.

FIG. 10A shows network response to individual mirror mode changes. Each row of the response matrix shows the network responded mirror coefficients under a unit change of each mirror deformation mode. After linear combining measured mirror modes (images below the title) with network responded coefficients, we obtained network estimated wavefront shape w.r.t. individual mirror mode changes (the 2^{nd} column). The 1st column shows phase retrieved wavefronts from beads imaged individual mirror mode changes. The PSFs were measured with 100-nm-diameter crimson beads. PSFs from −1.5 μm to 1.5 μm around the focus, with 0.1 μm step size, were collected for characterizing network responses. FIG. 10B shows Difference between network estimated wavefront and phase retrieved wavefront (the first two columns in FIG. 10A). The top row shows the pixel-wise differences between wavefronts obtained from network estimation and that obtained from phase retrieval. The plot below shows the root mean square wavefront error³ (W_{RMS}, Methods) of each wavefront difference. FIG. 10C shows similarity between network estimated wavefront and phase retrieved wavefront. The similarity is quantified with 2D normalized cross correlation (NCC).

FIG. 11A shows network response to individual mirror mode changes. Each row of the response matrix shows the network responded mirror coefficients under a unit change of each mirror deformation mode. After linear combining measured mirror modes (images below the title) with network responded coefficients, we obtained network estimated wavefront shape w.r.t. individual mirror mode changes. The PSFs were measured experimental blinking frames from immune-fluorescence labeled Tom20 specimen. 100 PSFs were used for calculating each network response. FIG. 11B shows difference between network estimated wavefront (left column in FIG. 11A) and phase retrieved from beads. The top row shows the pixel-wise differences between wavefronts obtained from network estimation and that obtained from phase retrieval. The plot below shows the root mean square wavefront error (W_{RMS}, Methods) of each wavefront difference. (FIG. 11C) Similarity between network estimated wavefront and phase retrieved wavefront. The similarity is quantified with 2D normalized cross correlation (NCC).

FIG. 12 shows DL-AO was compensating aberrations in different levels (in W_{RMS}, Methods) based on experimental blinking frames from immune-fluorescence-labeled Tom20 specimen. 20 camera frames were used for DL-AO estimation before each mirror update. The blinking data after DL-AO were compensation results after 19 mirror updates.

FIG. 13A shows examples of PSFs before and after DL-AO, when compensating artificially induced aberrations. Compensations are performed in real time during SMLM experiments. PSFs are measured from 100-nm-diameter crimson beads nearby the compensation area post SMLM acquisition. Scale bar: 5 μm. FIG. 13B shows PSFs are measured under instrument optimum (Methods) from 100-nm-diameter crimson beads. Scale bar: 5 μm. FIG. 13C shows quantitative comparisons between PSFs measured under instrument optimum and those measured before and after DL-AO using 3D normalized cross correlation (NCC).

FIG. 14A shows examples of PSFs before and after each mirror update, when compensating artificially induced aberrations with DL-AO. Compensations were performed in real time during SMLM experiments. The SMLM blinking frames for compensation were acquired from immune-fluorescence-labeled Tom20 specimen. PSFs were measured from 100-nm-diameter crimson beads nearby the compensation area post SMLM acquisition. Scale bar: 5 μm. ‘PSF #’ stands for number of sub-regions used for each DL-AO network estimation. ‘phase’ stands for pupil phase obtained by phase retrieval on the measured PSFs from beads. Each PSF was normalized to maximum equals to 1. FIG. 14B shows quantitative comparisons between PSFs measured under instrument optimum and those measured before and after each mirror update using 3D normalized cross correlation (NCC).

FIG. 15 shows the sub-regions shown in this figure are all the data used for network estimation before mirror update 1 and after mirror update 5 during DL-AO compensation. ‘p1’ stands for detection plane 1 and ‘p2’ stands for detection plane 2. The SMLM blinking frames for compensation were acquired from immune-fluorescence labeled Tom20 specimen. Network outputs a vector of mirror mode coefficients for each subregion. The wavefronts below each sub-region were obtained by linear combining measured mirror modes with output coefficients from neural network. The wavefronts were then used to simulate PSFs at different axial positions to check the similarity between measured PSFs and PSFs simulated from network estimations. PSFs were simulated without background and noise for visualization. Scale bars: 2 μm.

FIG. 16 panels A-B show summary of repeated tests of DL-AO for compensating aberrations of different levels (in W_{RMS}) based on simulated SMLM blinking data. Each simulated SMLM frames contain 128×128 pixels, with pixel size of 119 nm. Number of PSFs per frame were generated from Poisson distribution with a mean of 13. Axial positions of molecules were generated from uniform distribution from −1 to 1 μm range. The number of photon counts in each PSF was generated from exponential distribution with mean equal to 2500 and 1000 for A and B respectively. The number of background photon counts in each frame was set to be 10 and 50 for A and B respectively. FIG. 16 panel C shows summary of repeated tests of DL-AO for compensating aberrations in different levels (in W_{RMS}) based on experimental blinking frames from immune-fluorescence-labeled Tom20 specimen.

FIG. 17 shows the SMLM blinking frames for compensation were acquired from immune-fluorescence-labeled Tom20 specimen at 134 μm from bottom coverslip surface in water-based media (n=1.35). PSFs were measured from 100-nm diameter crimson beads nearby the compensation area post SMLM acquisition. Scale bar: 2 μm.

FIG. 18 shows each simulated SMLM frames contain 128×128 pixels, with pixel size of 119 nm. Number of PSFs per frame were generated from Poisson distribution with a mean of 13. Axial positions of molecules were set to be 0, or generated from uniform distribution from −0.8 to 0.8 μm range. The number of photon counts in each PSF was generated from exponential distribution with mean equal to 2500. The number of background photon counts in each frame was set to be 20. To compare DL-AO with metric-based AO with same initial aberration and same compensation mode, we chose measured mirror modes 3, 4, 1, 2, 6, 7, 5, 12, 13, 10, 11 (which resemble similar shape of Zernike Polynomials used in metric-based AO) to simulate PSFs containing aberration (Supplementary Note 3). The initial wavefront has distortion level of 0.5 radian in. We used the optimal setting suggested in metric based AO for compensation: maximum bias of 1 radian, 9 biases and 3 rounds.

FIG. 19 panel A shows 3D SMLM reconstruction of Tom20 imaged through 94 μm water-based media without AO, then reconstructed with in situ PSF model (INSPR). FIG. 19 panel B shows 3D SMLM reconstruction of Tom20 imaged through 94 μm water-based media with DL-AO, then reconstructed with INSPR. FIG. 19 panel X shows Axial cross-sections in A and B comparing cases without and with DL-AO combined with reconstruction methods of either in vitro PSF model (PR) or in situ PSF models (INSPR). The PR PSF model for no AO case was obtained from 100-nm diameter crimson bead next to the imaged area. The in vitro model for DL-AO was obtained from beads at bottom coverslip surface. Choices of in vitro model are made in order to find the closest match with corresponding experimental conditions. FIG. 19 panel D shows comparison of measured PSFs at 94 μm without and with DL-AO, in situ PSF models without and with DL-AO, and the instrument optimum. Scale bar: 2 μm.

FIG. 20 panel A shows 3D SMLM reconstruction of Tom20 imaged through 35 μm water-based media without AO, then reconstructed with in situ PSF model (INSPR). FIG. 20 panel B shows 3D SMLM reconstruction of Tom20 imaged through 35 μm water-based media with DL-AO, then reconstructed with INSPR. FIG. 20 panel C shows Axial cross-sections in A and B comparing cases without and with DL-AO combined with reconstruction methods of either in vitro PSF model (PR) or in situ PSF models (INSPR). The PR PSF model for no AO case was obtained from 100-nm-diameter crimson bead next to the imaged area. The in vitro model for DL-AO was obtained from beads at bottom coverslip surface. Choices of in vitro model are made in order to find the closest match with corresponding experimental conditions. FIG. 20 panel D shows Comparison of measured PSFs at 35 μm without and with DL-AO, in situ PSF models without and with DL-AO, and the instrument optimum. Scale bar: 2 μm.

FIG. 21A show identified spines, and the corresponding size measurements of their necks and heads. ‘Norm. I.’ stands for normalized intensity, where intensity in reconstructed image reflects counts of localized single molecules. ‘dist.’ stands for distance. The histograms show the raw intensity counts along the lines indicated by white arrows. Sizes are measured at the full widths at the half maximum intensity (Methods). The images of spines share the same scale bar as the first image, unless labeled specifically. FIG. 21B shows size measurements of spines' heads and necks from seven dendrites in immune-fluorescence-labeled Thy1-ChR2-EYFP in 150-250 μm brain sections of 7-week-old mice. The sizes were measured from super-resolution reconstructions of Thy1-ChR2-EYFP using SMLM with DL-AO through 150-μm-cut brain sections (Dendrite 1-3) and 250-μm-cut brain sections (Dendrite 4-7). Dendrite 1-7 were reconstructed at 67 μm, 67 μm, 83 μm, 134 μm, 134 μm, 126 μm, 132 μm from coverslip surface. The imaged structures were found at depths near the axial limit of tissue thicknesses. Optically measured tissue thicknesses vary among samples, which might be caused by variations in media volume between bottom and top coverslips.

FIGS. 22A-B show trade-off between compensation range and stability with DL-AO. FIG. 22A shows examples of PSFs before and after each mirror update, when compensating artificially induced aberrations with neural network trained from three different ranges. Compensations are performed based on blinking dyes on immune-fluorescence-labeled Tom20 specimen. PSFs are measured from 100-nm-diameter crimson beads nearby the compensation area post SMLM acquisition. Scale bar: 5 μm. ‘phase’ stands for pupil phase obtained by phase retrieval on the measured PSFs from beads. Each PSF was normalized to maximum equals to 1. FIG. 22B shows examples of proposed wavefront change per mirror update, when compensating artificially induced aberrations with neural network trained from three different ranges. ‘Wrms’ stands for root mean square wavefront error (Methods). The training ranges for network are shown in Table 4.

FIGS. 23A-D show characterizing neural network response to mirror mode changes using experimental PSFs. (FIGS. 23A-B) The responses of networks trained from two different ranges, in complement to the characterization for network 2 as shown in above examples. The three training ranges are shown in Table 4. Each row of the response matrix shows the network responded mirror coefficients under a unit change of each mirror deformation mode. After linear combining measured mirror modes with network responded coefficients, we obtained network estimated wavefront shape w.r.t. individual mirror mode changes. The experimental PSFs were obtained from fluorescent beads (31 PSFs imaged when scanning in axial dimension from −1.5 μm to 1.5 μm with a step size of 0.1 μm) and blinking molecules (100 PSFs) from immune-fluorescence-labeled Tom20 specimen. FIGS. 23C-D show pixel-wise differences and shape similarities between network estimated wavefronts and phase retrieved wavefronts, when estimating with network1 and network3 respectively. The top row shows the pixel-wise differences between network estimated wavefront and phase retrieved wavefront using beads. The row below that shows the pixel-wise differences between network estimated wavefront using blinking dyes on Tom20 specimen and phase retrieved wavefront using beads. The plot below that shows the root mean square wavefront error (W_{RMS}, Methods) of each wavefront difference. The plot on the bottom row shows the similarities between network estimated wavefronts and phase retrieved wavefronts, which are quantified with 2D normalized cross correlation (NCC).

FIG. 24 panels A-G show considerations in mirror mode generation. (Panel A) Comparison between expected wavefront deformation and the measured wavefront deformation when generating mirror mode voltage maps based on relative actuator vs. pupil position shown in grey area in Panel C. These were the mirror modes converted to Zernike polynomials for testing smNet's responses to Zernike modes in previous work. (Panel B) Comparison between expected wavefront deformation and the measured wavefront deformation after updating the relationship of actuator vs. pupil position in Panel C. These are the mirror modes used for DL-AO. (Panel C) Relationship of actuator vs. pupil position used for generating mirror mode voltage maps. (Panels D-F) Coupling between mirror modes. Each entry is the sum of element-wise multiplication between two mirror mode patterns, which are normalized by dividing root mean square of each pattern. The final matrix is further normalized by dividing the maximum of the entire matrix. (Panel G) Comparison between simulated actuator influence functions and those measured through phase retrieval.

FIG. 25 shows a measured mirror modes in optical setup. The mirror modes were measured with phase retrieval on 100-nm-diameter crimson beads (Methods). Each mirror deformation mode is generated by introducing a unit change in mirror mode voltage control. The level of distortion introduced by each mirror mode is estimated by calculating the root mean square wavefront error (W_{RMS}, Methods) of each phase retrieved wavefront. The unit W_{RMS} of is λ/2π.

FIG. 26 shows coupling between mirror modes used in DL-AO. Each entry is the sum of element-wise multiplication between two mirror mode patterns, which are divided by root mean square of each pattern to normalize to unit variance. The final matrix is normalized by dividing the maximum of the entire matrix.

FIG. 27 panels A-B show training data generation. (Panel A) PSFs and pupil functions measured under instrument optimum for two detection planes. (Panel B) Process of simulating aberrated PSFs with constructed wavefront distortion. The tip/tilt/defocus in Zernike Polynomials are added to pupil phase to generate PSFs at different x/y/z positions. The relative focal shift between two detection planes are added by relative defocus difference. FT stands for Fourier Transform of the pupil function. For each wavefront distortion, we can generate various biplane PSFs, the shape variations among which are caused by the variations in molecules' axial positions.

### DETAILED DESCRIPTION

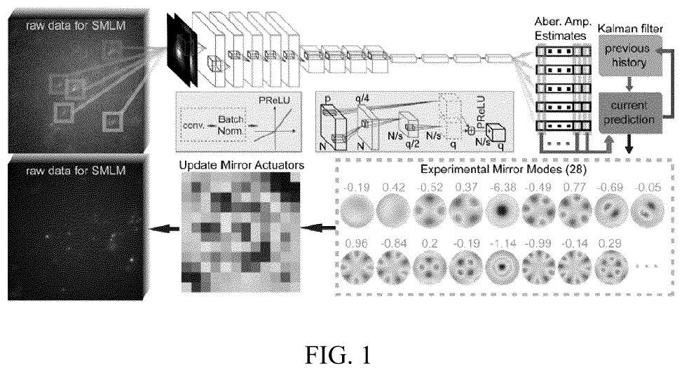

Single molecule emission patterns generated by individual fluorescence molecules carry information not only about their molecular center positions, but also about the shared wavefront distortion²⁵. The random lateral and axial positions of the blinking fluorescent molecules and their limited photons emitted in SMLM experiments, make these emission patterns unsuitable for direct wavefront measurement^{14,15}. Single molecule deep neural network (smNet)²⁶ was demonstrated in its capacity to infer wavefront distortions from individual PSFs in simulation and its responsiveness in experimental datasets. Moving from the inference task to active control of a deformable mirror driven by deep learning is, however, nontrivial. Here, we describe our developments in experimental wavefront based training, stacked estimation networks, and stabilized feedback controls through Kalman filter (FIG. 1).

Upon detection of SMLM frames, single molecule-containing sub-regions are segmented and sent to the network. Each input sub-region goes through a sequence of template matching processes, which are organized as convolutional layers and

residual blocks with PReLU activations³⁰ and batch normalizations in between, then “fully connects” through 1×1 convolutional layers to an output vector of values—amplitude estimates for wavefront shapes in terms of the native mirror deformation modes (hereafter referred to as mirror modes). Representing wavefront with coefficients of orthogonal basis helps cut down on the number of outputs and network parameters to be optimized in training. Forming this orthogonal basis directly from native mirror deformations further ensured the coefficients' accuracy in representing mirror responses. With this consideration, the conversion from mirror modes to Zernike polynomials—commonly used as the analytical basis to describe aberrations—is dropped to minimize mismatches between mirror responses and Zernike-based wavefront shapes. The residual differences between theoretical expectations and experimental mirror deformations are incorporated into training data generation.

To build an accurate link between experimentally detected emission patterns and the mirror control with neural networks, it is imperative to train the network with data that match those obtained experimentally. However, experimental training data of single molecules are challenging to obtain, since the ground-truth wavefronts are usually unknown and the extensive variations of the intensity, background, and the lateral and axial locations of single emitters, are impractical to cover experimentally. To this end, we simulate wavefront distortions by linearly combining the mirror deformations obtained experimentally in the SMLM system. We then use the coefficients of these experimental patterns to form the output of the network. The static residue of system aberration after optimizing the microscope system is also incorporated as the baseline of the wavefront shapes. This allows us to efficiently generate millions of training PSFs based on experimentally measured wavefronts with highly accurate training ground truth (normalized cross correlation (NCC) value of >0.95, comparing measured PSFs with those generated from network estimation).

Compensating wavefront distortions inferred from PSFs of blinking molecules, we found that the network proposed mirror change fluctuates with non-vanishing uncertainty before/after each mirror update. This uncertainty increases with the network training range, resulting in a trade-off between the compensation range and stability. To this end, we drive the deformable mirror by dynamically switching three networks trained with different aberration scales where the transitions between networks are based on the inference uncertainty. To stabilize network transitions, we employ Kalman filter to reduce the estimation uncertainty by recursively combining wavefront measurements before and after each correction. Due to the uncontrollable availability of single molecule emission patterns with a high signal-to-background ratio and the evolving PSFs after each correction, this process weighs heavily on high precision measurements against the uncertain ones to ensure stable feedback from the network.

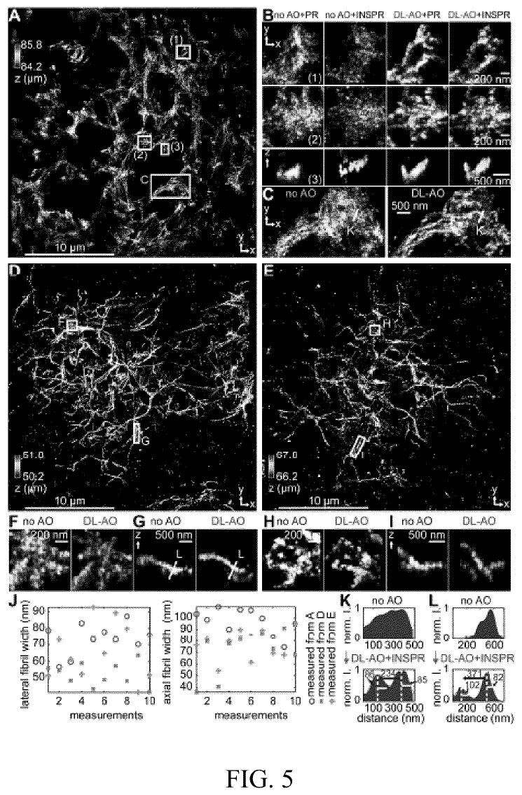

First, we characterized the response accuracy of DL-AO network using controlled wavefront distortions generated by the deformable mirror. These wavefront distortions resulted in aberrated emission patterns, which were then collected and sent to DL-AO network (Methods). By comparing the induced deformation amplitudes with those estimated by DL-AO, we observed that DL-AO network responded towards individual mirror deformations mostly in a one-to-one manner. And this behavior was consistently observed with both beads samples and blinking single molecules from immune-fluorescence-labeled cell specimens. At the same time, we also observed that DL-AO sensed changes in other mirror modes besides the one actually being changed, an expected behavior considering that mirror modes are coupled experimentally. Due to such coupling, mapping between the wavefront shape and mirror mode amplitudes is no longer unique, and therefore we further quantified the network response accuracy through wavefront shape errors and PSF similarities. We observed that independent measurements from DL-AO and phase retrieval using PSFs of fluorescent beads resulted in nearly identical wavefront shapes with a small difference of 0.13±0.02 rad (mean±s.t.d, N=28) quantified in root mean square wavefront error (Wrms, Methods, Supplementary FIG. 4). Further, comparing the wavefronts estimated by DL-AO network using single molecule blinking data (100 PSFs) to that retrieved by phase retrieval from beads, we observed high similarities of 0.83±0.06 (mean±s.t.d, N=28, normalized cross correlation), and a small wavefront difference of 0.15±0.03 rad (mean±s.t.d, N=28) in Wrms. For the majority of our introduced distortions below 3 radians in Wrms, a single mirror update can already reduce the wavefront error by 50% (FIG. Panels 2E, 2F). Caused by the nonlinear mirror deformation response to control input³⁶, and the decreased network response amplitudes with the decreasing signal to noise level or the increasing network training range, we observed that it usually requires 3-20 mirror updates for full compensation.

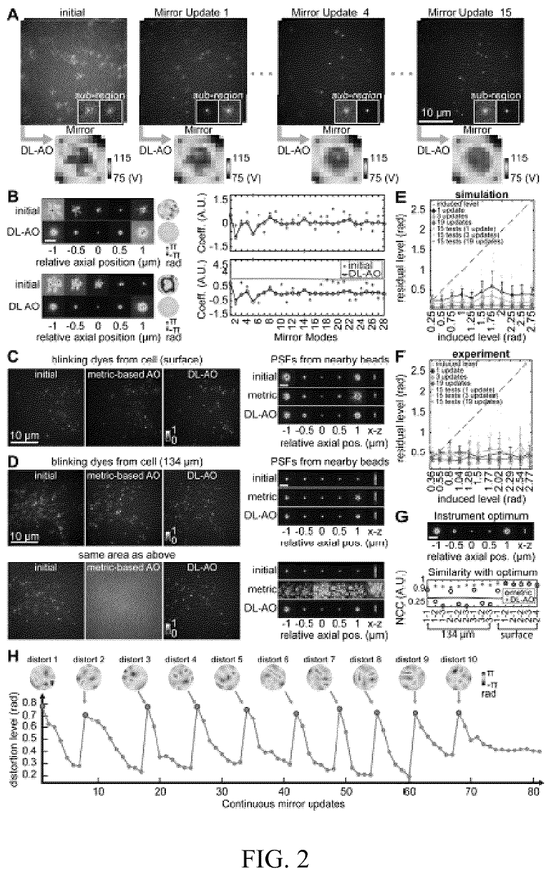

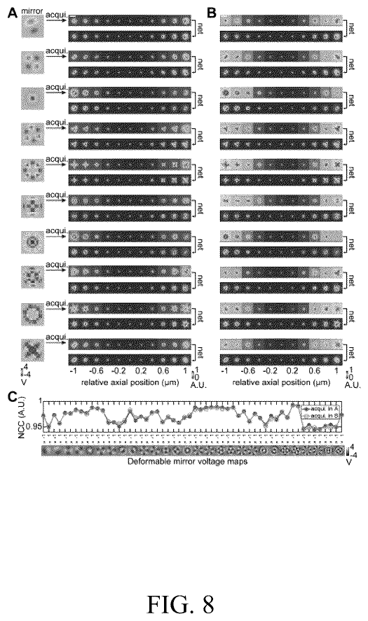

DL-AO aims to restore PSFs to the level unmodified by the specimen. To characterize DL-AO's capacity for PSF restoration, we introduced random wavefront distortions using the deformable mirror and compensated these distortions with DL-AO during SMLM experiments with immune fluorescence-labeled TOM20 in COS-7 cells. Visualizing the raw blinking data during the correction, we found the PSFs became less distorted even after a single compensation, and the mirror shape became stable after ˜4 mirror updates (FIG. 2 Panel A). Since PSFs from blinking molecules have limited photons and stochastic positions, making them challenging to quantify, we further verified the PSF shape post correction by axially scanning fluorescent beads nearby the compensation areas. Through phase retrieval, we found DL-AO results share a highly similar and flat wavefront shape with the instrument optimum (Methods, Supplementary Note 4), with a residual of 0.29±0.12 rad in Wrms (mean±s.t.d, N=11, FIG. 2 Panel B). Comparing the PSFs post DL-AO and the instrument optimum, high similarities of 0.95±0.02 (mean±s.t.d, N=11) were consistently achieved, quantified by 3D normalized cross correlation (FIG. 2 Panel B, Supplementary FIG. 8), and remained 0.96±0.01 (mean±s.t.d, N=11 in NCC) for distortion levels from 0.25 to 2.75 radians in Wrms. Often, this level of restoration was achieved with only 3-6 mirror updates, and a single mirror update from DL-AO network reduced the wavefront error by 61.2%±24.2% (mean±s.t.d, N=11). To drive each mirror update, as few as two sub-regions containing isolated single emitters were used for DL-AO network estimation, which spent an average of 0.1 second for forward propagation and made DL-AO suitable for real-time compensation during SMLM acquisition.

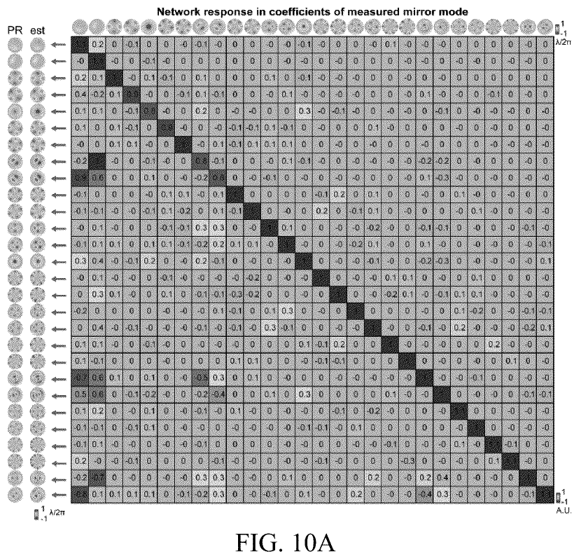

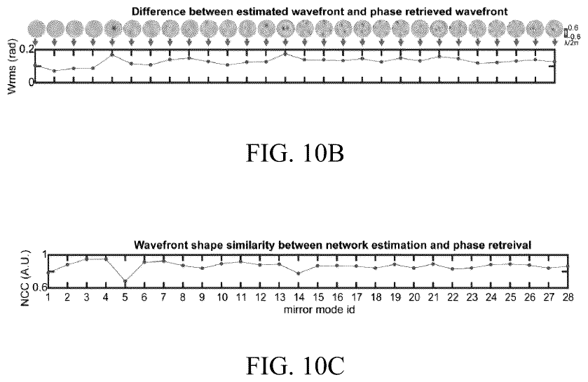

Next, we evaluated the robustness of DL-AO on compensating different levels of wavefront distortion, from 0.25 to 2.75 radians in Wrms, by assessing the residual wavefront error post correction using both simulation and single molecule blinking data. After one mirror update, we observed that 51.9±9.3% and 64.3±12.8% (mean±s.t.d, N=165) of the induced level was compensated for experimental and simulated data, respectively (FIG. 2 Panels E-F). After 19 mirror updates, the residual level was 0.32±0.02 and 0.08±0.03 (mean±s.t.d, N=165) radians respectively for experimental and simulated data (Supplementary FIG. 10). This is a significant improvement, as compared to existing metric-based methods, for example, Robust and Effective Adaptive Optics in Localization Microscopy (REALM), which works up to 1 radian at the expense of 10 mirror updates per aberration mode, requiring a total of 330 updates to compensate 11 aberration types (3 rounds). In addition, metric-based AO is unstable when imaging volumetric cellular structures (FIG. 2 Panels C, D, G). A detailed discussion and quantification of these intrinsic limitations of metric-based methods can be found in the Examples.

Inhomogeneous refractive indices within cells and tissues redirect and scatter light. In particular, the mismatches between refractive indices in sample media and objective immersion media reduce the shape modulation of the single molecule emission patterns axially and broaden the focus laterally (FIG. 2 Panel D), increasing the localization uncertainty in all directions and thus worsening the resolution of SMLM. Such resolution deterioration becomes more drastic with an increasing imaging depth.

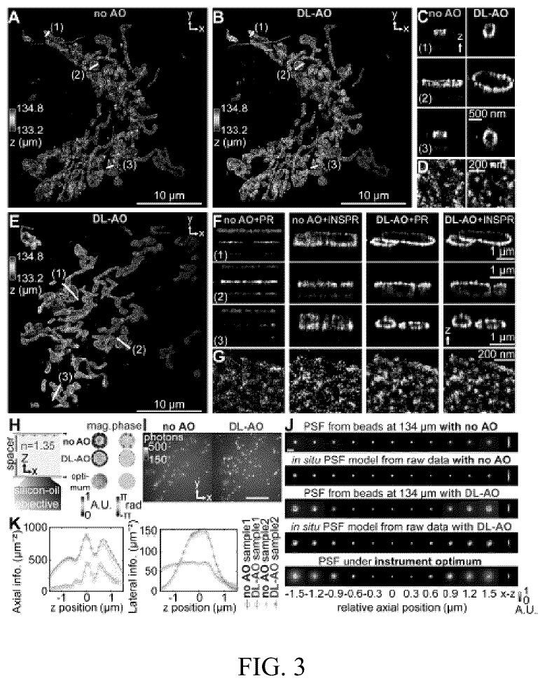

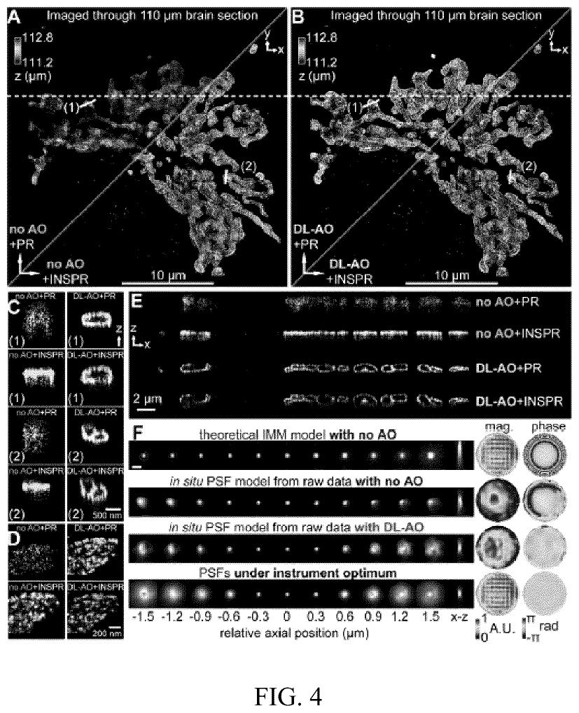

Here, we demonstrate DL-AO's capacity in compensating significant index mismatch induced aberrations using constructed specimens from 35 μm to 134 μm in thickness with water-based imaging media. Imaging immune-fluorescence-labeled Tom20 in COS-7 cells through such thickness without AO correction, the super resolution images of Tom20 proteins showed nearly no axial distributions (visualized by color differences, FIG. 3 Panel A), a consequence of the severe lack of shape modulation along the axial direction due to the large imaging depth. While the raw data for both cases in the comparison were acquired in an interleaved manner without and with AO (Methods), DL-AO reconstruction showed the expected outer membrane contours of mitochondria, and without AO the reconstruction displayed significant artifacts (FIG. 3 Panels B, C). Zooming in on the lateral dimension, we observed the aggregations of Tom20 proteins, known to form clusters³⁷, when aberrations were corrected by DL-AO. In comparison, without DL-AO, the lateral reconstruction of Tom20 distribution is diffusive (FIG. 3 Panels D, G), as a result of deteriorated lateral resolution through the large imaging depth. This resolution contrasts without and with DL-AO are consistently observed with different samples (FIG. 3 Panels E-G).

Next, we illustrate the mechanism behind such resolution improvement (FIG. 3 Panels H-K) by looking at the PSFs and pupil function, which summarizes how the sample together with optical system modulates the collected light, before and after AO. In comparison to the near uniform distribution of magnitude and phase in the pupil obtained from an in vitro bead, wavefront (phase in the retrieved pupil) showed significant radial variations and increased phase wrappings at large radial positions (FIG. 3 Panel H). As a result, the PSFs at different axial positions throughout a 2 μm axial range remained nearly invariant (FIG. 3 Panel J). Such loss of PSF shape modulation results in localization artifacts where identical axial positions are falsely assigned to molecules despite their axial distributions. In contrast, DL-AO restored the flatness of the wavefront, resulting in PSFs that are highly similar to the instrument optimum (FIG. 3 Panels H, J). These improvements in PSF sharpness and modulation explain the resolution improvement post DL-AO (FIG. 3 Panels C, D, F, G) and are further quantified statistically showing significantly increased Fisher information content per photon upon DL-AO correction (FIG. 3 Panel K).

We further demonstrated DL-AO on arbitrary tissue-induced aberrations by imaging through 200-μm thick unlabeled brain sections resolving membrane of mitochondria using immune fluorescence-labeled Tom20 in COS-7 cells (FIG. 4 Panels A-L). Without DL-AO, our observation is consistent with those through water based cavities where the information of Tom20's axial distribution is lost even with in situ PSF model (FIG. 4 Panel A). Further deterioration is observed both laterally and axially (FIG. 4 Panels A, F) using in vitro PSF model with theoretical index mismatch aberration incorporated. With DL-AO, the 3D reconstruction shows improved resolution, where such improvement can be visualized laterally by the distinct Tom20 protein clusters and axially by the mitochondria membrane contours (FIG. 4 Panels B-E).

Combing the power of single molecule deep neural network with careful designs in network training, feedback, and instrument control, we demonstrated that DL-AO optimizes PSFs approaching the instrument optimum during SMLM experiments, and restores the resolution of 3D SMLM through >130 μm depth of tissue. However, DL-AO requires at least two isolated and detectable PSFs to start compensation, and this requirement might be challenging to meet when the aberration level or imaging depth is significantly higher than the demonstrated cases where single molecule emissions are no longer identifiable. We also expect that further development in designing training data and neural network architecture will improve inference accuracy of DL-AO in an increasing compensation range, ultimately enabling single shot compensation during SMLM imaging. Additionally, the demonstrated DL-AO applications are limited by the working distance of the silicone-oil objective, and thus the imaging depth could potentially be extended when combined with long working distance objectives. To further improve the achievable resolution and imaging fidelity, we expect that DL-AO can be combined with light-sheet illumination^{49,50} for an increased signal to background ratio of single molecule detections, tissue clearing⁵¹ for labeling penetration and reduced aberration level, and expansion methods⁵² for further improved spatial resolution, thereby opening doors to observe nanoscale conformation in tissues and small animals.

### INCORPORATION BY REFERENCE

References and citations to other documents, such as patents, patent applications, patent publications, journals, books, papers, web contents, have been made throughout this disclosure, including to the Supplementary. The Supplementary, and all other such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

### EXAMPLES

### Example 1: Methods

### Preparation of Fluorescent Beads on Coverslips

We cleaned 25-mm-diameter coverslips (CSHP-No 1.5-25, Bioscience Tools) successively in ethanol (2701, Decon) and HPLC-grade water (W5-4, Fisher Chemical) for three times and then dried them with compressed air. To promote fluorescent beads adhesion on coverslip, 200 μL of 546 poly-l-lysine solution (P4707, Sigma-Aldrich) was added to one coverslip and incubated for 20 min at room temperature (RT). Following poly-l-lysine treatment, the coverslip was subsequently rinsed with deionized water. For beads incubation, we first diluted 100-nm-diameter crimson beads (custom-designed, Invitrogen) to 1:1,000,000 in deionized water. Then we added 200 μL of the diluted bead solution to the center of the coverslip and incubated for 20 min at RT. The coverslip was subsequently rinsed with deionized water. The treated coverslip was placed on a custom-made holder, and 20 μL of 38% 2,2′-thiodiethanol (166782, Sigma-Aldrich) in 1×PBS (10010023, Gibco) was added to its center. Another 25-mm-diameter coverslip (also cleaned by using the above protocol) was placed on top of this coverslip. This coverslip sandwich was sealed with two-component silicone dental glue (Twinsil speed 22, Dental-Produktions und Vertriebs GmbH).

### Cell Culture

COS-7 cells (CRL-1651, ATCC) were grown on coverslips placed in six-well plates and cultured in DMEM (30-2002, ATCC) with 10% FBS (30-2020, ATCC) and 1% penicillin-streptomycin (15140122, Gibco) at 37° C. with 5% CO2. The cells are passaged when their confluence reaches 80%. And the cells were fixed for imaging when their confluence reaches about 30%.

### Fixation and Labeling of Tom20 in COS-7 Cells

Cultured cells were first fixed with 37° C. pre-warmed 3% Formaldehyde aqueous solution (diluted in 1×PBS from 16% Formaldehyde aqueous solution, 15710, Electron Microscopy Sciences) and 0.5% Glutaraldehyde aqueous solution (diluted in 1×PBS from 8% Glutaraldehyde aqueous solution, 16019, Electron Microscopy Sciences), with gently rocking at room temperature (RT) for 15 min. After fixation, cells were rinsed twice with 1×PBS and then quenched for 7 min with freshly prepared 0.1% NaBH4 (452882, Sigma-Aldrich) in 1×PBS. The cells were rinsed three times with 1×PBS and blocked with solution containing 3% BSA (001-000-162, Jackson ImmunoResearch) and 0.2% Triton X-100 in 1×PBS, with gently rocking at RT for 1 h. After blocking, the cells were incubated at 4° C. overnight with primary antibody (sc-11415, Santa Cruz Biotechnology), 1:500 diluted in antibody dilution buffer (1% BSA and 0.2% Triton X-100 in 1×PBS). We then washed cells three times with 5 min each time in 0.05% Triton X-100 in 1×PBS, and incubated cells at RT for 5 h with secondary antibody (A21245, Invitrogen, for Alexa Fluor 647), 1:500 diluted in antibody dilution buffer (1% BSA and 0.2% Triton X-100 in 1×PBS). After being washed three times with 5 min each time in 0.05% Triton X-100 in 1×PBS, cells were post-fixed with 4% Formaldehyde aqueous solution (1:4 diluted with 1×PBS from 16% Formaldehyde aqueous solution, Electron Microscopy Sciences) at RT for 10 min. Cells were then rinsed three times with 1×PBS and stored in 1×PBS at 4° C.

### Fixation and Labeling of Amyloid-β in Mouse-Brain Sections

The 5×FAD Alzheimer's disease (AD) mouse model was used for immunostaining amyloid β. Mice were maintained on the C57BL/6J (B6) background, which were purchased from the Jackson Laboratory (JAX MMRRC Stock #034848). The 5×FAD transgenic mice overexpress the following five familial Alzheimer's disease (FAD) mutations under control of the Thy1 promoter: the APP (695) transgene containing the Swedish (K670N, M671L), Florida (I716V), and London (V7171) mutations, and the PSEN1 transgene containing the M146L and L286V FAD mutations33. Up to five mice were housed per cage with SaniChip bedding and LABDIET (animal food) 5K52/5K67 (6% fat) feed. The colony room was kept on a 12:12 h light/dark schedule with the lights on from 7:00 am to 7:00 pm daily. The mice were bred and housed in specific-pathogen-free conditions. Only female mice were used. Mice were euthanized by perfusion with ice-cold phosphate-buffered saline (PBS) following full anesthetization with AVERTIN (Tribromoethanol) (125-250 mg/kg intraperitoneal injection)53. Animals used in the study were housed in the Stark Neurosciences Research Institute Laboratory Animal Resource Center, Indiana University School of Medicine. All animals were maintained, and experiments performed in accordance with the recommendations in the Guide for the Care and Use of Laboratory Animals of the National Institutes of Health. The protocol was approved by the Institutional Animal Care and Use Committee (IACUC) at Indiana University School of Medicine.

Perfused brains from mice at 7.5 months of age were fixed in 4% formaldehyde in aqueous solution (1:4 diluted with 1×PBS from 16% Formaldehyde Aqueous Solution, Electron Microscopy Sciences) for 24 h at 4° C. Following fixation, brains were cryoprotected in 30% sucrose at 4° C., and then cut into sections of 150 μm by a vibratome (7000smz-2, Campden Instruments). For immunostaining, free-floating sections were washed and permeabilized with 0.1% Triton X-100 in 1×PBS (PBST), and antigen retrieval was subsequently performed using 1× Reveal Decloaker (Biocare Medical) at 85° C. for 10 min. Sections were blocked in 5% normal donkey serum (D9663 Sigma-Aldrich) in PBST for 1 h at RT. The sections were then incubated with β-Amyloid Antibody (Cell Signaling Technology #2454, rabbit), 1:1000 diluted in 5% normal donkey serum in PBST at 4° C. overnight. Sections were washed and stained for 1 h at RT with secondary antibody (A31573, Invitrogen, for Alexa Fluor 647) diluted at 1:1000 in 5% normal donkey serum in PBST54.

### Fixation and Labeling of Thy1+ Pyramid Cells in Mouse Brain Sections

To obtain mice expressing the proper amount of ChR2-EYFP in Thy1+ pyramidal cells, the litters of Thy1-ChR2-EYFP (B6.Cg-Tg (Thy1-COP4/EYFP)18Gfng/J, Jackson Lab) cross with B6 (C57BL/6, Jackson Lab) were used for the labeling. To extract the brains for sectioning, the litters of seven-week-old were first anesthetized by intraperitoneal injections of a mix of 90 mg/kg ketamine (59399-114-10, Akron) and 10 mg/kg xylazine (343750, HVS). After confirmation of deep anesthesia, the abdomen was open to expose the diaphragm. The chest cavity was then opened by cutting through the diaphragm and ribs to expose the heart. The trans-cardiac perfusion was performed by inserting the needle into the left ventricle and a small incision at the right atrium. Mice were perfused with 1×PBS (1:10 diluted from DSP32060, Dot Scientific). After the liver was pale, mice were continuously perfused with 4% Formaldehyde Aqueous Solution (1:8 diluted with 1×PBS from 32% Formaldehyde Aqueous Solution, Electron Microscopy Sciences) to pre-fix the brain until the muscle turned stiff. Brains were carefully collected and placed in 4% Formaldehyde Aqueous Solution to post-fix at 4° C. overnight. The fixed brains were trimmed for coronal slicing. The trimmed brains were fixed and cut into sections of 150 μm, 200 μm and 250 μm by a vibratome (1000 Plus, TPI Vibratome). The brain sections were washed three times, 15 min for each time, in wash buffer (0.1% Triton X-100 in 1×PBS) with a gentle shake (120 rpm, Orbi-Shaker, Benchmark), and then were incubated in blocking butter (5% BSA (A9647, Sigma-Aldrich) in 1×PBS) for 1.5 h with a gentle shake. The blocked brain sections were incubated with chicken anti-GFP antibody (ab13970, Abcam, diluted to 1:1,000 in blocking buffer) at 4° C. overnight. After being washed three times in the wash buffer as in the first step, the slices were incubated with goat anti-chicken Alexa Fluor 647-conjugated antibody (A21449, Invitrogen, diluted to 1:600 in wash buffer) at room temperature for 2 h with a gentle rocking. All animals were maintained, and experiments performed in accordance with the recommendations in the Guide for the Care and Use of Laboratory Animals of the National Institutes of Health. The protocol was approved by the Institutional Animal Care and Use Committee (IACUC) at Purdue University.

### Imaging Buffer and Sample Mounting for SMLM

Immediately before SMLM imaging, the coverslip with specimens on top was placed on a custom-made holder6. Imaging buffer55 (10% (wt/vol) glucose in 50 mM Tris, 50 mM NaCl, 10 mM MEA, 50 mM BME, 2 mM COT, 2.5 mM PCA and 50 nM PCD, pH 8.0) was added to the coverslip. Then another cleaned coverslip was placed on top of the imaging buffer. This coverslip sandwich was sealed with two-component silicone dental glue. Samples with immune fluorescence-labeled cells on the top coverslips were prepared as described below: 200 μL of poly-l-lysine solution was added to the bottom coverslip, incubated for 20 min and subsequently rinsed with deionized water. Then 20 μL of microsphere suspension (134 μm in diameter, 7640A, Thermo Scientific) was spread around the outer ring area of the coverslip, and incubated at RT until the coverslip was dried. Then we placed this coverslip with microspheres at the bottom, added 50-80 μL imaging buffer without touching the microspheres, and added the coverslip with cells on top of it, with the cell-side surface facing down.

### Microscope Setup

All experimental data were recorded on a custom-designed SMLM setup built around an Olympus IX-73 microscope stand (Olympus America). This system is equipped with a 100×/1.35-NA (numerical aperture) silicone oil-immersion objective lens (UPLSAPO100XS, Olympus America), a PIFOC objective positioner (ND72Z2LAQ, Physik Instrumente), a three axis piezo nano-positioning systems (Nano-LP100, Mad City Labs) and a manual XY stage (MicroStage-LT, Mad City Labs Inc.). A continuous-wave laser at wavelength of 642 nm (2RU659 VFL-P-2000-642-B1R, MPB Communications) was coupled into a polarization-maintaining single-mode fiber (PM-S405-XP, Thorlabs) after passing through an acousto-optic tunable filter (AOTFnC-400.650-TN, AA Opto-electronic) for power modulation. The excitation light coming out of the fiber was focused to the pupil plane of the objective lens after passing through a filter cube holding a quadband dichroic mirror (Di03-R405/488/561/635-t1, Semrock). The emission fluorescence was split with a 50/50 non-polarizing beam splitter (BS016, Thorlabs) mounted on a kinematic base (KB25/M, Thorlabs). The separated fluorescent signals were delivered by two mirrors onto a 90° specialty mirror (47-005, Edmund Optics), passed through a band-pass filter (FF01-731/137-25), and were then projected on an sCMOS camera (Orca-Flash4.0v3, Hamamatsu) with an effective pixel size of 119 nm on the sample plane. The detection planes that received the signals transmitted and reflected by the beam splitter were referred to as plane 1 and plane 2, respectively. The pupil plane of the objective lens was imaged onto a deformable mirror (Multi-3.5, Boston Micromachines). The imaging system was controlled by a custom written program in LabVIEW (National Instruments).

### Measurement of Mirror Deformation Modes

The experimental mirror deformation modes25 (Supplementary Note 1) were measured using fluorescent bead sample described above. We introduced a positive and a negative (unit amplitude) mirror changes for each of the 28 mirror deformation modes. For each mirror shape setting, we acquired PSFs at z positions from −1.5 μm to 1.5 μm, with a step size of 100 nm, a frame rate of 10 Hz, and 3 frames per z position. Pupil phase was extracted through phase retrieval algorithm for each mirror change. To obtain the experimental mirror deformation bases without the influences of instrument or sample induced aberrations, we calculated the differences of the retrieved pupil phases between the positive and negative unit changes of mirror modes and divided them by two. The actual distortion level introduced by each experimental mirror mode is quantified through root mean square wavefront error28 (Methods, Supplementary Note 3).

### Measurement of Instrument Optimum

We define instrument optimum as the status where optical hardware was optimized to limit the inherent system aberrations. To obtain this optimized status, we followed a previously described method⁶, where the deformable mirror was adjusted as follows. Starting from the flat voltage map (provided by the manufacturer) of the deformable mirror, 28 mirror modes were applied sequentially. For each mirror mode, 11 different amplitudes were applied while recording the corresponding fluorescence signal from an in-focus 100-nm crimson bead sample. To extract the fluorescence signal from individual beads, the symmetry center of each imaged bead was obtained using the radial symmetry method56. Subsequently, a symmetric 2D Gaussian was generated at the symmetry center and was multiplied by the isolated emission pattern from the fluorescent bead, generating a Gaussian-masked image, and then the total intensity of the masked image was calculated to extract the center peak signal of the beads in focus. For each mirror mode, images of the bead were acquired at 11 different mirror mode amplitudes and the corresponding center peak signals of the bead were extracted as described above. The optimal amplitude (i.e. the amplitude providing the highest center peak signal from the beads) was determined from a quadratic fit of these 11 signal measurements vs. mirror mode amplitudes. After identifying optimal amplitudes for each of the 28 modes, these amplitudes were added to the flat voltage map (provided by the manufacturer), serving as the starting point for another iteration. This iterative process was repeated five times to achieve optimal system aberration correction. PSFs under instrument optimum were measured using fluorescent beads sample described above. Data were acquired at a series of z positions from 1.5 μm to 1.5 μm, with a step size of 100 nm, a frame rate of 10 Hz, and 3 frames per z position. Phase retrieval algorithm was then performed on the bead stack to obtain the pupil function under instrument optimum. The instrument optimum can be further verified by decomposing the pupil phase into Zernike mode12 and checking whether the absolute values of first 64 Zernike coefficients (Wyant order28) are smaller than 0.2λ/2π.

### Calculation of Mean Square Wavefront Error

The root mean square wavefront errors (Wᵣₘₛ) were calculated by the root mean square among all pixels within in the image of pupil phase angle Wᵣₘₛ for experimental wavefronts were either calculated using the pupil phase obtained by phase retrieval from fluorescent beads (Supplementary, Fig. SS4), or calculated using the wavefront images composed of linear combination of experimental mirror deformation modes as estimated by DL-AO (FIG. 2 Panels E, F, Supplementary FIGS. 4, 7-9, 12, 13, 717 15).

### Measurement of Network Responses to Individual Mirror Deformation Modes

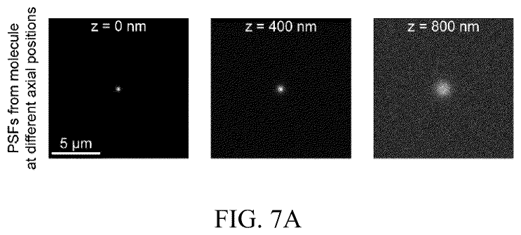

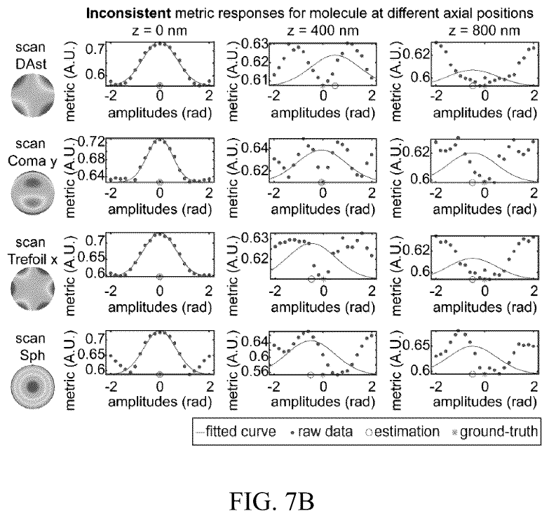

The aberrated PSFs for characterizing network responses (Supplementary FIGS. 7-9) were measured using either Tom20 specimens or fluorescent bead samples described above. The samples were first excited with the 642-nm laser at a low intensity of ˜50 W/cm² to find regions of interest. Then data containing single molecule blinking events were collected at a laser intensity of 2-6 kW/cm² and a frame rate of 50 Hz. The aberrated PSFs from the fluorescent bead samples were measured the same way as we measured PSFs under instrument optimum. A set of PSF measurements were performed under positive and negative unit changes of each mirror deformation mode, the differences of network output between positive and negative mirror changes were calculated and divided by two to be the final response vector for each mirror deformation mode.

SMLM Acquisition with DL-AO

In SMLM data acquisition, the fluorescently labeled samples were first excited with a 642-nm laser at a low intensity of ˜50 W/cm2 to find a region of interest. Imaging depths of mitochondria specimens were measured by the differences of PIFOC readings between the apparent focus of the region-of-interest and the bottom coverslip surface. The imaging depths for immune fluorescence-labeled tissue specimens were measured by the differences of PIFOC readings between apparent focuses of the region-of-interest and the fluorescent signal closest to bottom coverslip surface. Before SMLM experiments, bright-field images of this region were recorded over an axial range from −1 to +1 μm with a step size of 100 nm as reference images for focus stabilization⁵⁷. Then the blinking data were collected at a laser intensity of 2-6 kW/cm² and a frame rate of 50 Hz, where the first 3-20 cycles were used for DL-AO, with 20-100 frames per cycle. In the case where significant background photons were observed (100 per pixel per frame), a temporal median filter was used to estimate structured background for each pixel. This background map was subtracted from each camera frame before the frames are segmented into sub-regions for DL-AO processing. After DL-AO correction, 2000 frames were collected per cycle, and 20-120 cycles (50000-236000 frames, Supplementary Table 2) were collected per imaging area. For the interleaved SMLM imaging without and with AO, deformable mirror shape was set to switch between DL-AO compensated shape and the shape used for instrument optimum (Methods) per imaging cycle (2000 frames). Acquisition of no-AO data was performed first in the interleaved sequence for fair comparison. Upon each switch between no-AO and DL-AO acquisitions, PIFOC objective positioner was moved to compensate apparent focal shift in the case of index mismatch induced aberration58. The focal shifts were determined by an estimated linear relationship between the apparent focus shift and the amplitudes of two radially symmetric mirror deformation modes. The shifts per unit amplitude changes were empirically estimated to be −0.3 μm for mirror mode 5 and −0.2 μm for mirror mode 15 (Supplementary, Fig. SS4). Here, a negative movement of PIFOC objective positioner corresponds to shifting the imaging plane closer to the bottom coverslip surface.

### Structure Size Quantification in the Reconstructed Images

The neck sizes of dendritic spines are measured as follows. First we selected a profile line at the location where measurement is to be made. A rectangular box was then cropped along the line, with its width ranging from 50-500 nm (depending on the spine neck length and the number of localizations). The localization result inside this rectangular box was isolated and rendered into an image with 3 nm pixel size. Each point in the rendered image is blurred with a Gaussian kernel of 3 pixels in width. Intensity profile was generated along the profile line by sum projection and subsequently the histogram was normalized by dividing its maximum value. The spine neck sizes were calculated by the full width at the half maximum of the intensity histogram. Spine head sizes were measured the same way as that for the spine necks. The Amyloid β fibrils' widths were measured the same way as that for the spine necks, except for a Gaussian function was used to fit the line profile (‘fit’, Curve Fitting Toolbox 2020a, MATLAB R2020a, The MathWorks, Inc.), with Gaussian function switched between ‘gauss1’ (single Gaussian fit) and ‘gauss2’ (two Gaussians) depending on the number of peaks observed in intensity histogram. The half width at the half maximum of the fitted Gaussian curve is treated as the width of each fibril.

### Example 2: Resolving Amyloid-β (Aβ) Fibrils Through 125 μm Mouse Brain Sections

The 3D structures of amyloid-β (Aβ) fibrils are a focus of interest in the studies of Alzheimer's disease (AD) and are of particular importance with the success of amyloid-directed therapeutics^{38,39}. Visualizing the formation and aggregation of these fibrils within the brain has been limited by the significant resolution loss when imaging through tissues. With DL-AO adaptively optimizing single molecule emission patterns during SMLM imaging, we can now clearly resolve the organization of immune-fluorescence-labeled β-amyloid fibrils in 125 μm thick brain sections from 5×FAD mice, a transgenic AD model that exhibits robust amyloid plaque pathology similar to that found in the human AD brain40 (FIG. 5 Panels A-L). We imaged Aβ fibrils through these thick brain tissues without and with DL-AO in an interleaved manner. We observed improved resolution in both axial and lateral directions with DL-AO in comparison with that of no-AO (FIG. 5 Panel B). Importantly, driven by DL-AO, SMLM reconstruction revealed the 3D organization of individual amyloid fibrils entangling and forming the plaque. However, while without DL-AO, the resolution deteriorates, making the intricate fibril ultrastructure look like blurry clusters (FIG. 5 Panels B, C). In addition, inspection of the axially color-coded lateral images and axial cross-section revealed that the fibril structures in the axial direction were distorted and flattened without DL-AO. A similar phenomenon was observed in the presence of spherical aberrations in the previous evaluation of mitochondria membranes (FIGS. 3, 4, 5B, 5C). Interestingly, with DL-AO, our reconstructed super-resolution images using in vitro or in situ PSF models revealed highly similar results, suggesting that DL-AO has restored the aberrated emission patterns approaching the instrument optimum. Combining DL-AO with INSPR, we imaged fibril structures in different plaque areas (FIG. 5 Panels D-I), and were able to consistently resolve individual fibrils and revealed their 3D arrangements within plaques at various stages (FIG. 5 Panels F-I). Measuring the width of Aβ fibrils in tissues, we obtained an averaged width of about 52±9 nm (mean±s.t.d, N=30) and 72±19 nm (mean±s.t.d, N=30) in lateral and axial cross-sections, respectively (FIG. 5 Panel J). We note that these measured fibril widths have slight variations among different imaged plaques.

### Example 3: Resolving Dendritic Spines Through 150-250 μm Mouse Brain Sections

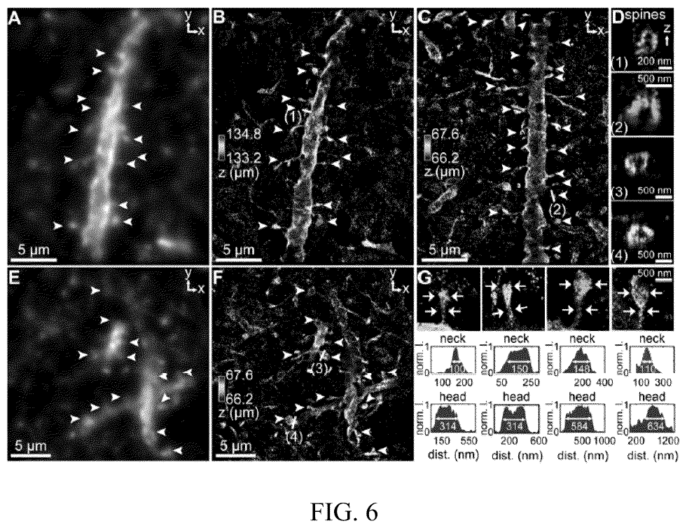

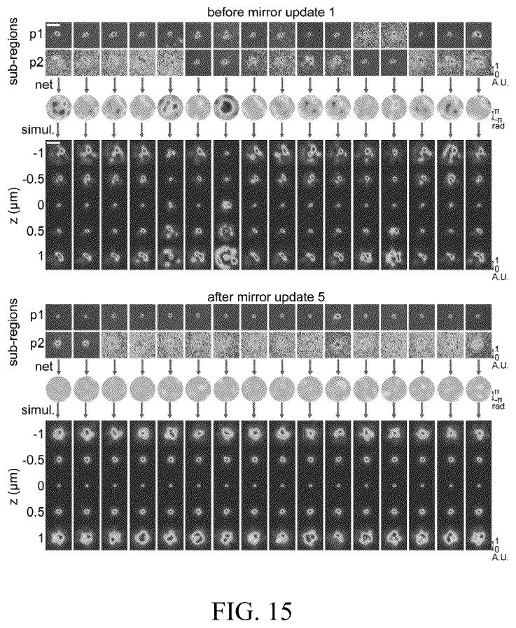

Using deep learning driven adaptive optics to correct sample induced aberrations, and in situ PSF model to perform super resolution reconstruction post-AO correction, we performed SMLM imaging through 150-250 μm thick brain tissues resolving dendritic spines, the 300-800 nm tiny protrusions from the dendrites whose morphology changes in response to neuronal activities associated with learning and memory41,42. Insufficient spatial resolution leads to an erroneous classification of spines43,44 due to their miniature sizes. The capacity to resolve spines' ultrastructure within their tissue environment is critical in detecting morphological changes in the same area of the functional measurements. This technological advancement will allow electrophysiological and morphological mapping of the same neural circuits linking functional and structural synaptic plasticity with animal behavior⁴⁵. We imaged Thy1-ChR2-EYFP transgenic mice, expressing Channelrhodopsin-2 enhanced yellow fluorescent protein (EYFP) fusion protein in cortical L5 Thy1+ pyramidal cells⁴⁶. Through a 250-μm-thick brain section, we resolved the distinct membrane distribution of the fluorescently tagged target decorating the dendritic spines (FIG. 6 Panels A-G, Supplementary FIG. 15). Throughout the resolved volume of spines, we can observe the membrane-bounded structures as hollow tubes and blobs (FIG. 6 Panel D). Besides, the very thin neck of spines can be clearly visualized (FIG. 6 Panel E, Supplementary FIG. 15), which provides more accurate information about the dimension of spines. We also imaged 150-μm-thick mouse brain sections (FIG. 6 Panels B, C), where thinner sections provide a better signal to background ratio. Interestingly, we observed a few occurrences where dendrite membranes labeled ChR2-EYFP appeared to be twisted in the final reconstructed images (FIG. 6 Panel C), which may represent a type of physical substrate for decreasing gain for synaptic inputs^{47,48}. We obtained an average localization precision of 13 nm and 57 nm in lateral and axial dimensions when imaging through the 250-μm-thick brain section, and 11-52 nm (lateral-axial) precision when imaging through the 150-μm-thick brain section. The capacity to resolve and accurately quantify the shape and size of dendritic spines throughout large tissue thickness paves the way to link spine morphology and function and will facilitate studies of learning, memory, and brain disorders.

### Example 4: Inconsistent Responses in Metric-Based AO

FIG. 7A shows simulated emission patterns from single molecules at different axial positions. FIG. 7B shows metric values vs. amplitudes of mirror shapes. Each metric value was calculated through a weighted sum of the Fourier transform of an acquisition under certain mirror shape. The acquisitions were simulated as images with 400×400 pixels and 65 nm pixel size. Each acquisition contains one PSF with 10000 photon counts and 10 background photon counts. Each row shows the changes in metric values when scanning the amplitudes of a mirror shape shown on the left. Different columns show metrics calculated from PSFs at different axial positions. ‘DAst’ and ‘Sph’ stand for Diagonal Astigmatism and Primary Spherical in Zernike polynomials.

### Example 5: Comparison Between Measured PSFs and PSFs Simulated from Network Estimations

FIG. 8 panels A-B show a comparison between PSFs measured under different deformable_mirror voltage maps and PSFs simulated from network estimations. Network estimations were obtained by inputting 31 biplane sub-regions, each of which contains a single PSF measured from 100-nm-diameter crimson bead, then averaging among the 31 outputs. The 31 sub-regions were measured by moving Piezo stage from −1.5 μm to 1.5 μm around the focus of the first detection plane, with 0.1 μm step size. Only PSFs from first detection plane were shown in this figure for comparison. PSFs were simulated without background and noise for visualization. Scale bar: 2 μm. ‘acqui.’ stands for acquisition. ‘net’ stands for network estimation.

FIG. 8 panel C shows a quantitative comparisons between measured PSFs under different mirror voltage maps and PSFs simulated from network estimations w.r.t. the measured PSFs. The similarities between measured PSFs and simulated PSFs were quantified using 3D normalized cross correlation (NCC). Acquisition in FIG. 8 panel A has relatively higher signal level comparing to acquisition in FIG. 8 panel B. The NCC values were calculated between PSFs simulated from network estimations (w.r.t. measurements under either higher signal or lower signal) and the PSFs measured under higher signal level as examples shown in FIG. 8 panel A.

### Example 6: Comparison Between Measured PSFs and PSFs Simulated from Network Estimations Based on a Single Measurement of an Isolated Molecule

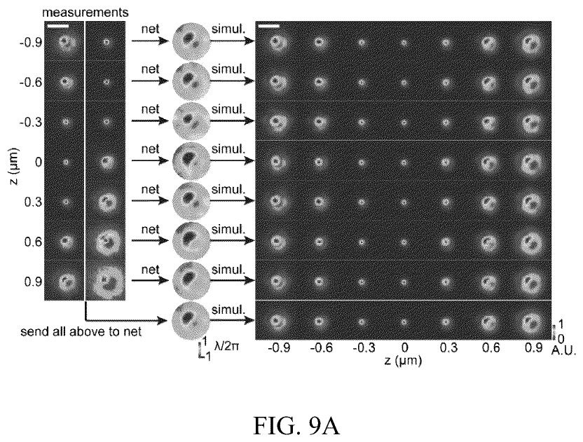

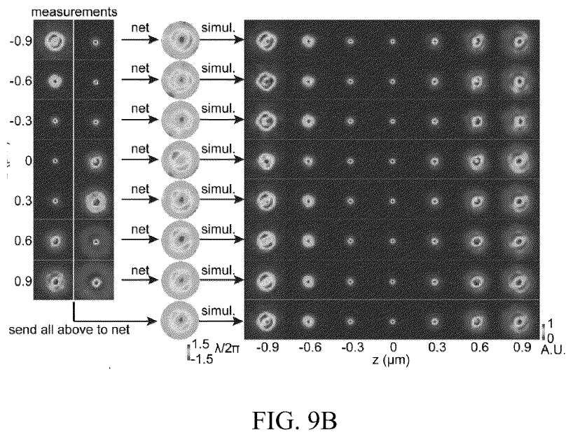

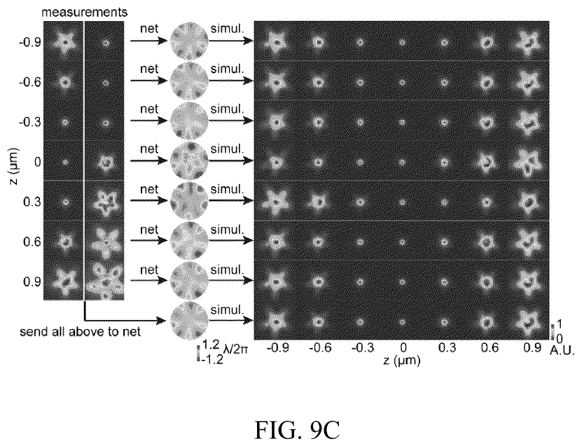

FIGS. 9A-C show comparison between measured PSFs and PSFs simulated from network estimations based on a single measurement of an isolated molecule The left column shows measured PSFs from 100-nm-diameter crimson beads when scanning Piezo stage at different axial positions. The measured PSFs in biplane sub-regions were sent to neural network, which outputs a vector of mirror mode coefficients for each sub-region. The measured mirror modes were linear combined with mirror mode coefficients output from network, which result in wavefronts shown in the middle column. The wavefront for network estimations based on all measured PSFs were generated with an averaged value among network outputs w.r.t. PSFs at different axial positions. The wavefront were then used to simulate PSFs at different axial positions to check the similarity between measured PSFs and PSFs simulated from network estimations. PSFs were simulated without background and noise for visualization. Scale bars: 2 μm.

### Example 7: Characterizing Neural Network Responses to Mirror Mode Changes Using PSFs Measured from Fluorescent Beads

FIG. 10A shows network response to individual mirror mode changes. Each row of the response matrix shows the network responded mirror coefficients under a unit change of each mirror deformation mode. After linear combining measured mirror modes (images below the title) with network responded coefficients, we obtained network estimated wavefront shape w.r.t. individual mirror mode changes (the 2^{nd} column). The 1st column shows phase retrieved wavefronts from beads imaged individual mirror mode changes. The PSFs were measured with 100-nm-diameter crimson beads. PSFs from −1.5 μm to 1.5 μm around the focus, with 0.1 μm step size, were collected for characterizing network responses. FIG. 10B shows Difference between network estimated wavefront and phase retrieved wavefront (the first two columns in FIG. 10A). The top row shows the pixel-wise differences between wavefronts obtained from network estimation and that obtained from phase retrieval. The plot below shows the root mean square wavefront error (W_{RMS}, Methods) of each wavefront difference. FIG. 10C shows similarity between network estimated wavefront and phase retrieved wavefront. The similarity is quantified with 2D normalized cross correlation (NCC).

### Example 8: Characterizing Neural Network Responses to Mirror Mode Changes Using PSFs Measured from Blinking Molecules

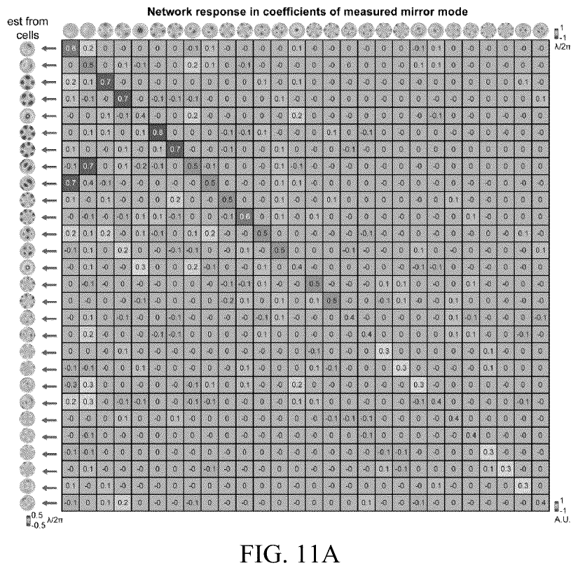

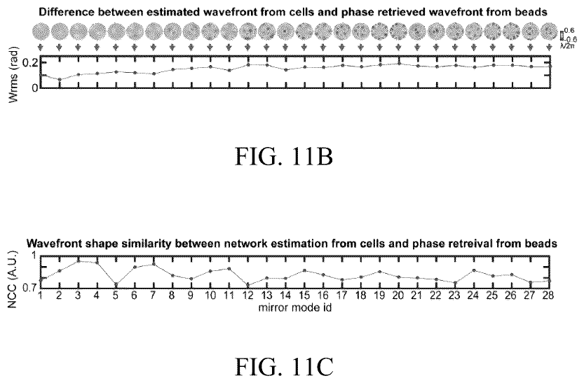

FIG. 11A shows network response to individual mirror mode changes. Each row of the response matrix shows the network responded mirror coefficients under a unit change of each mirror deformation mode. After linear combining measured mirror modes (images below the title) with network responded coefficients, we obtained network estimated wavefront shape w.r.t. individual mirror mode changes. The PSFs were measured experimental blinking frames from immune-fluorescence labeled Tom20 specimen. 100 PSFs were used for calculating each network response. FIG. 11B shows difference between network estimated wavefront (left column in FIG. 11A) and phase retrieved from beads. The top row shows the pixel-wise differences between wavefronts obtained from network estimation and that obtained from phase retrieval. The plot below shows the root mean square wavefront error (W_{RMS}, Methods) of each wavefront difference. (FIG. 11C) Similarity between network estimated wavefront and phase retrieved wavefront. The similarity is quantified with 2D normalized cross correlation (NCC).

### Example 9: SMLM Frames Before and After DL-AO Compensating Various Amount of Induced Aberrations

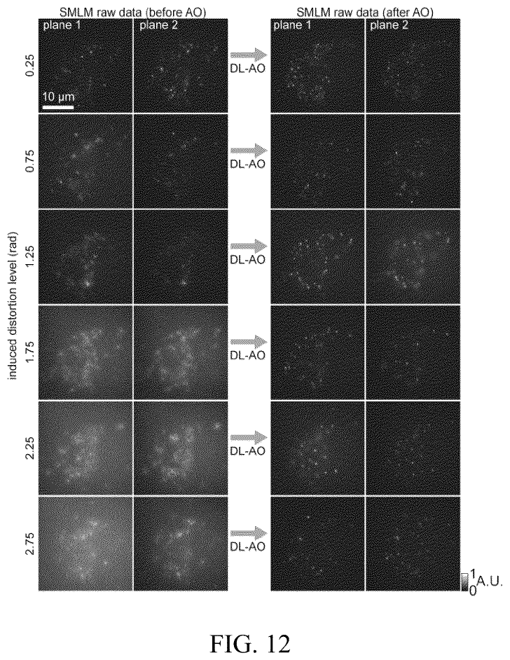

FIG. 12 shows DL-AO was compensating aberrations in different levels (in W_{RMS}, Methods) based on experimental blinking frames from immune-fluorescence-labeled Tom20 specimen. 20 camera frames were used for DL-AO estimation before each mirror update. The blinking data after DL-AO were compensation results after 19 mirror updates.

### Example 10: PSFs Before and After DL-AO at Various Amount of Induced Aberrations

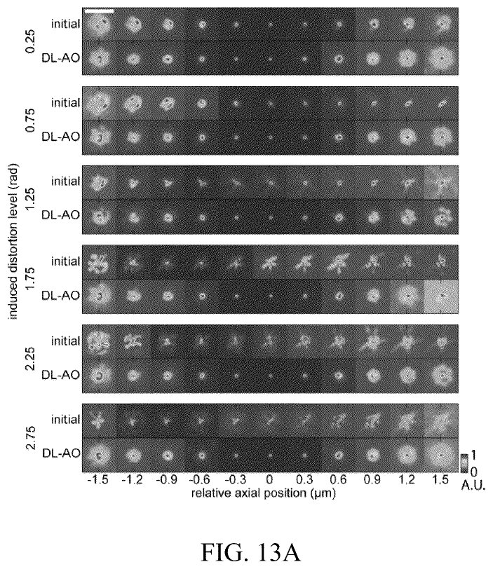

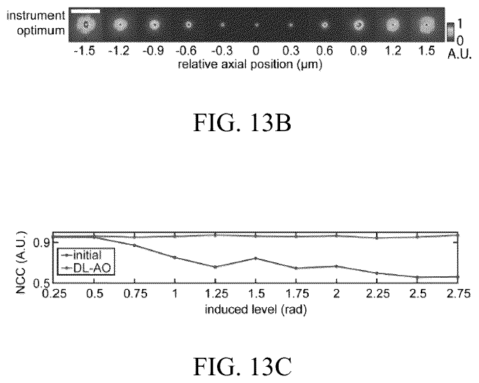

FIG. 13A shows examples of PSFs before and after DL-AO, when compensating artificially induced aberrations. Compensations are performed in real time during SMLM experiments. PSFs are measured from 100-nm-diameter crimson beads nearby the compensation area post SMLM acquisition. Scale bar: 5 μm. FIG. 13B shows PSFs are measured under instrument optimum (Methods) from 100-nm-diameter crimson beads. Scale bar: 5 μm. FIG. 13C shows quantitative comparisons between PSFs measured under instrument optimum and those measured before and after DL-AO using 3D normalized cross correlation (NCC).

### Example 11: PSF Shape Before and After Each Mirror Update During DL-AO Compensation

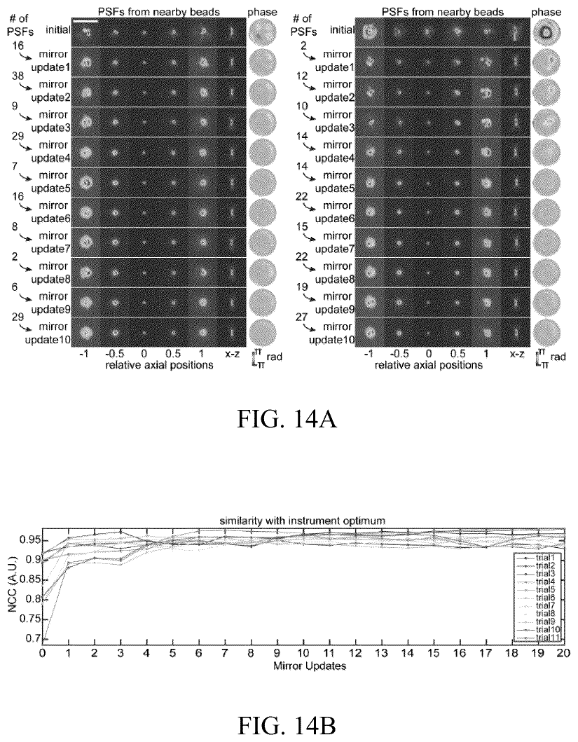

FIG. 14A shows examples of PSFs before and after each mirror update, when compensating artificially induced aberrations with DL-AO. Compensations were performed in real time during SMLM experiments. The SMLM blinking frames for compensation were acquired from immune-fluorescence-labeled Tom20 specimen. PSFs were measured from 100-nm-diameter crimson beads nearby the compensation area post SMLM acquisition. Scale bar: 5 μm. ‘PSF #’ stands for number of sub-regions used for each DL-AO network estimation. ‘phase’ stands for pupil phase obtained by phase retrieval on the measured PSFs from beads. Each PSF was normalized to maximum equals to 1. FIG. 14B shows quantitative comparisons between PSFs measured under instrument optimum and those measured before and after each mirror update using 3D normalized cross correlation (NCC).

### Example 12: Sub-Regions from Raw Blinking Frames and Network Estimation Per Sub-Region During DL-AO Compensation

FIG. 15 shows the sub-regions shown in this figure are all the data used for network estimation before mirror update 1 and after mirror update 5 during DL-AO compensation. ‘p1’ stands for detection plane 1 and ‘p2’ stands for detection plane 2. The SMLM blinking frames for compensation were acquired from immune-fluorescence labeled Tom20 specimen. Network outputs a vector of mirror mode coefficients for each subregion. The wavefronts below each sub-region were obtained by linear combining measured mirror modes with output coefficients from neural network. The wavefronts were then used to simulate PSFs at different axial positions to check the similarity between measured PSFs and PSFs simulated from network estimations. PSFs were simulated without background and noise for visualization. Scale bars: 2 μm.

### Example 13: Repeated Tests of DL-AO

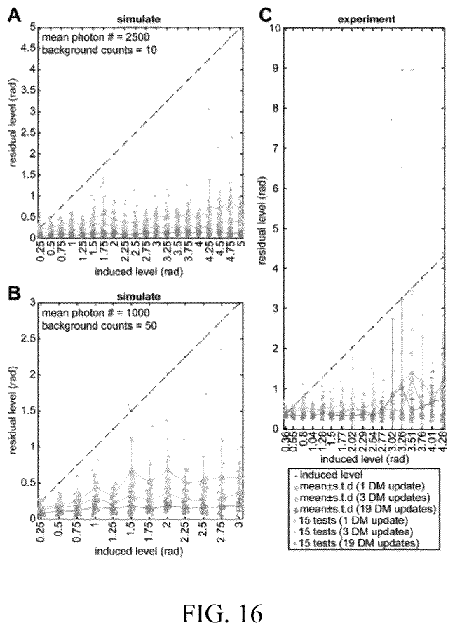

FIG. 16 panels A-B show summary of repeated tests of DL-AO for compensating aberrations of different levels (in W_{RMS}) based on simulated SMLM blinking data. Each simulated SMLM frames contain 128×128 pixels, with pixel size of 119 nm. Number of PSFs per frame were generated from Poisson distribution with a mean of 13. Axial positions of molecules were generated from uniform distribution from −1 to 1 μm range. The number of photon counts in each PSF was generated from exponential distribution with mean equal to 2500 and 1000 for A and B respectively. The number of background photon counts in each frame was set to be 10 and 50 for A and B respectively. FIG. 16 panel C shows summary of repeated tests of DL-AO for compensating aberrations in different levels (in W_{RMS}) based on experimental blinking frames from immune-fluorescence-labeled Tom20 specimen.

### Example 14: Comparison Between DL-AO and Metric-Based AO on Compensating Sample Induced Distortion

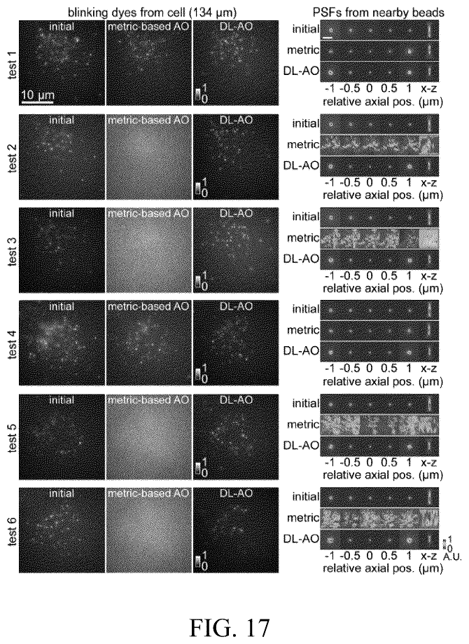

FIG. 17 shows the SMLM blinking frames for compensation were acquired from immune-fluorescence-labeled Tom20 specimen at 134 μm from bottom coverslip surface in water-based media (n=1.35). PSFs were measured from 100-nm diameter crimson beads nearby the compensation area post SMLM acquisition. Scale bar: 2 μm.

### Example 15: Comparison Between DL-AO and Metric-Based AO in Simulation

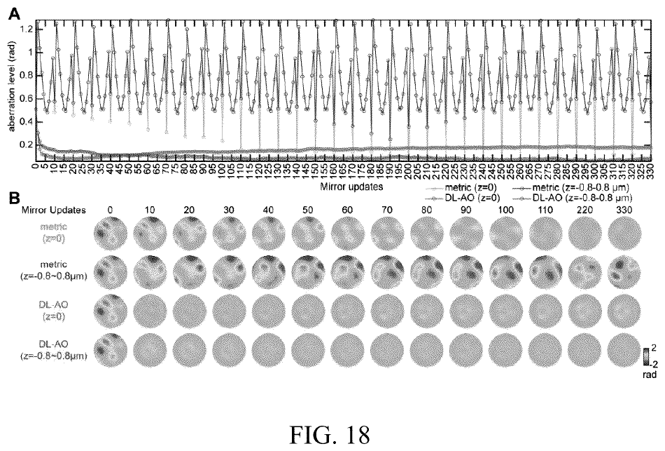

FIG. 18 shows each simulated SMLM frames contain 128×128 pixels, with pixel size of 119 nm. Number of PSFs per frame were generated from Poisson distribution with a mean of 13. Axial positions of molecules were set to be 0, or generated from uniform distribution from −0.8 to 0.8 μm range. The number of photon counts in each PSF was generated from exponential distribution with mean equal to 2500. The number of background photon counts in each frame was set to be 20. To compare DL-AO with metric-based AO with same initial aberration and same compensation mode, we chose measured mirror modes 3, 4, 1, 2, 6, 7, 5, 12, 13, 10, 11 (which resemble similar shape of Zernike Polynomals used in metric-based AO) to simulate PSFs containing aberration (Supplementary Note 3). The initial wavefront has distortion level of 0.5 radian in. We used the optimal setting suggested in metric based AO for compensation: maximum bias of 1 radian, 9 biases and 3 rounds.

### Example 16: Demonstrations of DL-AO Correcting Index Mismatch Induced Aberration by Imaging Tom20 Proteins in COS-7 Cells Through 94 μm Water-Based Imaging Media

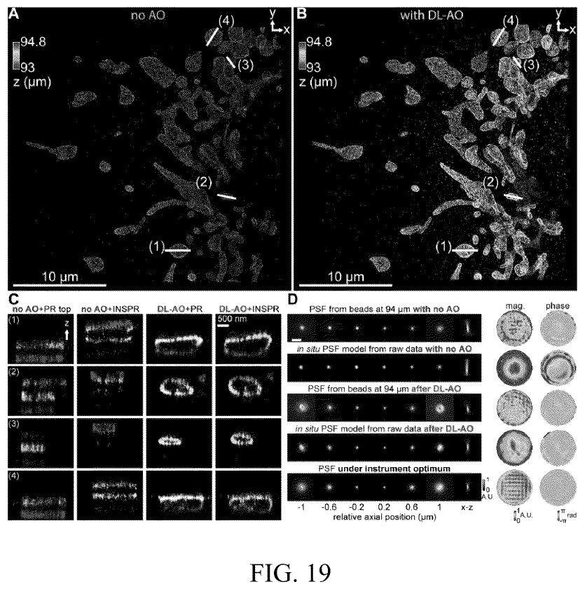

FIG. 19 panel A shows 3D SMLM reconstruction of Tom20 imaged through 94 μm water-based media without AO, then reconstructed with in situ PSF model (INSPR). FIG. 19 panel B shows 3D SMLM reconstruction of Tom20 imaged through 94 μm water-based media with DL-AO, then reconstructed with INSPR. FIG. 19 panel X shows Axial cross-sections in A and B comparing cases without and with DL-AO combined with reconstruction methods of either in vitro PSF model (PR) or in situ PSF models (INSPR). The PR PSF model for no AO case was obtained from 100-nm diameter crimson bead next to the imaged area. The in vitro model for DL-AO was obtained from beads at bottom coverslip surface. Choices of in vitro model are made in order to find the closest match with corresponding experimental conditions. FIG. 19 panel D shows comparison of measured PSFs at 94 μm without and with DL-AO, in situ PSF models without and with DL-AO, and the instrument optimum. Scale bar: 2 μm.

### Example 17: Demonstrations of DL-AO Correcting Index Mismatch Induced Aberration by Imaging Tom20 Proteins in COS-7 Cells Through 35 μm Water-Based Imaging Media

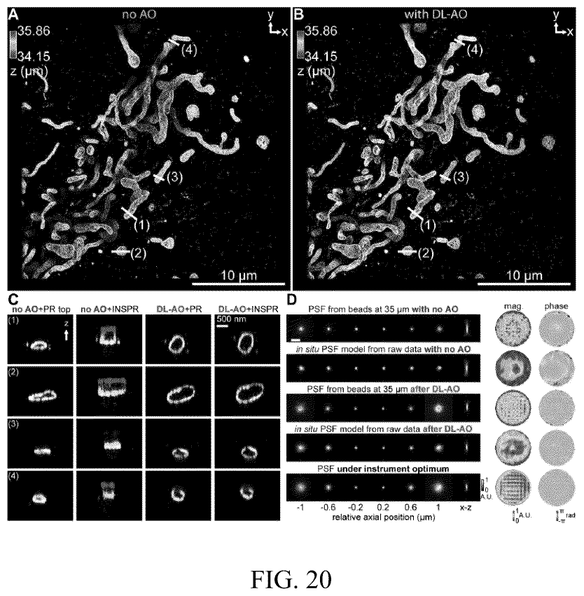

FIG. 20 panel A shows 3D SMLM reconstruction of Tom20 imaged through 35 μm water-based media without AO, then reconstructed with in situ PSF model (INSPR). FIG. 20 panel B shows 3D SMLM reconstruction of Tom20 imaged through 35 μm water-based media with DL-AO, then reconstructed with INSPR. FIG. 20 panel C shows Axial cross-sections in A and B comparing cases without and with DL-AO combined with reconstruction methods of either in vitro PSF model (PR) or in situ PSF models (INSPR). The PR PSF model for no AO case was obtained from 100-nm-diameter crimson bead next to the imaged area. The in vitro model for DL-AO was obtained from beads at bottom coverslip surface. Choices of in vitro model are made in order to find the closest match with corresponding experimental conditions. FIG. 20 panel D shows Comparison of measured PSFs at 35 μm without and with DL-AO, in situ PSF models without and with DL-AO, and the instrument optimum. Scale bar: 2 μm.

### Example 18: Size Measurements of Spines' Heads and Necks

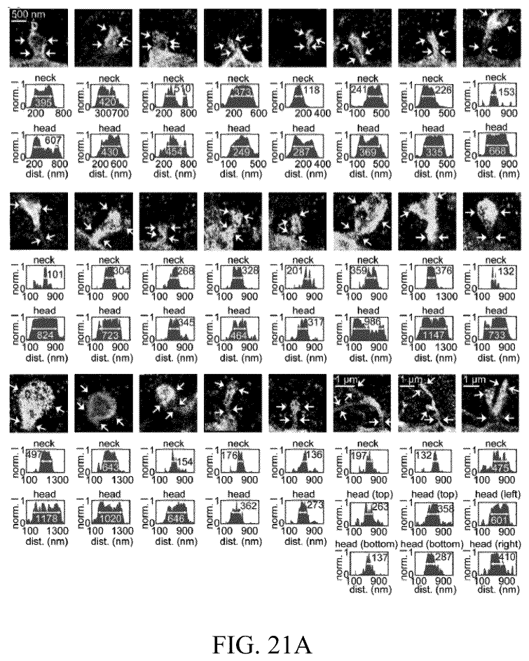

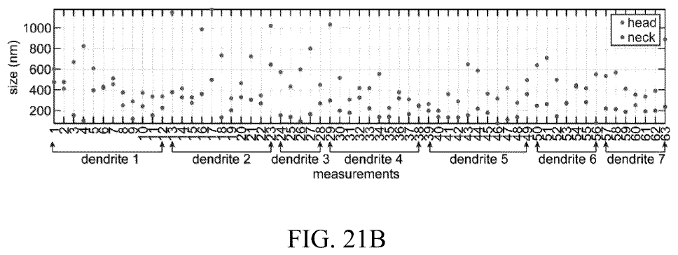

FIG. 21A show identified spines, and the corresponding size measurements of their necks and heads. ‘Norm. I.’ stands for normalized intensity, where intensity in reconstructed image reflects counts of localized single molecules. ‘dist.’ stands for distance. The histograms show the raw intensity counts along the lines indicated by white arrows. Sizes are measured at the full widths at the half maximum intensity (Methods). The images of spines share the same scale bar as the first image, unless labeled specifically. FIG. 21B shows size measurements of spines' heads and necks from seven dendrites in immune-fluorescence-labeled Thy1-ChR2-EYFP in 150-250 μm brain sections of 7-week-old mice. The sizes were measured from super-resolution reconstructions of Thy1-ChR2-EYFP using SMLM with DL-AO through 150-μm-cut brain sections (Dendrite 1-3) and 250-μm-cut brain sections (Dendrite 4-7). Dendrite 1-7 were reconstructed at 67 μm, 67 μm, 83 μm, 134 μm, 134 μm, 126 μm, 132 μm from coverslip surface. The imaged structures were found at depths near the axial limit of tissue thicknesses. Optically measured tissue thicknesses vary among samples, which might be caused by variations in media volume between bottom and top coverslips.

### Example 19: Data Tables

TABLE 1
Imaging parameters for experimental data

| | Number of | Apparent | Mean | Mean | Mean | Mean | Mean | |
|---|---|---|---|---|---|---|---|---|
| | Frames | focal plane | √ CRLBₓ | √ CRLB_{y} | √ CRLB_{z} | photon | background | Number of |
| Datasets | acquired | depth (μm) | (nm) | (nm) | (nm) | counts | counts | localizations |
| FIG. 3B (Tom20) | 100,000 | 134 | 9.4 | 9.1 | 50.0 | 2,946 | 68 | 1,090,416 |
| FIG. 3E (Tom20) | 116,000 | 134 | 10.2 | 9.3 | 46.7 | 2,893 | 67 | 1,478,280 |
| FIG. 4B (Tom20) | 116,000 | 112 | 10.7 | 9.2 | 48.8 | 2,641 | 64 | 1,729,048 |
| FIG. 5A (amyloid β) | 220,000 | 65 | 13.4 | 12.6 | 56.8 | 2,920 | 130 | 1,155,993 |
| FIG. 5D (amyloid β) | 66,000 | 51 | 10.7 | 10.7 | 51.0 | 3,091 | 88 | 396,333 |
| FIG. 5E (amyloid β) | 54,000 | 67 | 11.5 | 11.0 | 51.1 | 3,645 | 142 | 170,683 |
| FIG. 6A | 146,000 | 134 | 13.5 | 13.4 | 56.9 | 3,848 | 222 | 958,608 |
| (Thy1-ChR2-EYFP) | | | | | | | | |
| FIG. 6B | 138,000 | 67 | 11.3 | 11.2 | 51.6 | 2,972 | 93 | 2,407,206 |
| (Thy1-ChR2-EYFP) | | | | | | | | |
| FIG. 6D | 236,000 | 67 | 11.1 | 10.9 | 51.6 | 2,708 | 86 | 2,648,649 |
| (Thy1-ChR2-EYFP) | | | | | | | | |
| Supp. FIG. 16 (Tom20) | 70,000 | 92 | 9.7 | 8.8 | 49.6 | 3,677 | 95 | 805,107 |
| Supp. FIG. 17 (Tom20) | 152,000 | 35 | 7.8 | 8.0 | 39.8 | 3,355 | 49 | 2,367,528 |
| Supp. FIG. 18A | 136,000 | 126 | 12.0 | 12.0 | 54.3 | 3,473 | 150 | 1,099,482 |
| (Thy1-ChR2-EYFP) | | | | | | | | |

TABLE 2
Detailed sizes in each layer of the network architecture

| Building blocks | | Convolutional | | | | | | | | |
|---|---|---|---|---|---|---|---|---|---|---|
| (index) | Components in each building block | Kernal size | | | Stride size | | | Output size | | |
| Conv (1) | Convolutional layer^{4,5} | | 2 × 7 × 7 | | | 1 | | | 64 × 32 × 32 | |
| | → Batch normalization | | | | | | | | | |
| | → PReLU** | | | | | | | | | |
| Conv (2) | Same as above | | 64 × 5 × 5 | | | 1 | | | 128 × 32 × 32 | |
| Res* (1-3) | Convolutional layer | | 128 × 3 × 3 | | | 1 | | | 32 × 32 × 32 | |
| | → Batch normalization | {open oversize bracket} | 32 × 3 × 3 | {close oversize bracket} | {open oversize bracket} | 1 | {close oversize bracket} | {open oversize bracket} | 64 × 32 × 32 | {close oversize bracket} |
| | → Convolutional layer | | 64 × 3 × 3 | | | 1 | | | 128 × 32 × 32 | |
| | → Batch normalization | | | | | | | | | |
| | → Convolutional layer | | | | | | | | | |
| | → sum with output of “shortcut” connection⁺ | | | | | | | | | |
| | → PReLU | | | | | | | | | |
| Res (4) | Convolutional layer | | 128 × 3 × 3 | | | 1 | | | 64 × 32 × 32 | |
| | → Batch normalization | {open oversize bracket} | 64 × 3 × 3 | {close oversize bracket} | {open oversize bracket} | 4 | {close oversize bracket} | {open oversize bracket} | 128 × 8 × 8 | {close oversize bracket} |
| | → Convolutional layer | | 128 × 3 × 3 | | | 1 | | | 256 × 8 × 8 | |
| | → Batch normalization | | | | | | | | | |
| | → Convolutional layer | | | | | | | | | |
| | → sum with output of “shortcut” connection⁺⁺ | | | | | | | | | |
| | → PReLU | | | | | | | | | |
| Res (5-7) | Convolutional layer | | 256 × 3 × 3 | | | 1 | | | 64 × 8 × 8 | |
| | → Batch normalization | {open oversize bracket} | 64 × 3 × 3 | {close oversize bracket} | {open oversize bracket} | 1 | {close oversize bracket} | {open oversize bracket} | 128 × 8 × 8 | {close oversize bracket} |
| | → Convolutional layer | | 128 × 3 × 3 | | | 1 | | | 256 × 8 × 8 | |
| | → Batch normalization | | | | | | | | | |
| | → Convolutional layer | | | | | | | | | |
| | → sum with output of “shortcut” connection⁺ | | | | | | | | | |
| | → PReLU | | | | | | | | | |
| Res (8) | Convolutional layer | | 1024 × 3 × 3 | | | 1 | | | 256 × 8 × 8 | |
| | → Batch normalization | {open oversize bracket} | 256 × 3 × 3 | {close oversize bracket} | {open oversize bracket} | 8 | {close oversize bracket} | {open oversize bracket} | 512 × 1 × 1 | {close oversize bracket} |
| | → Convolutional layer | | 512 × 3 × 3 | | | 1 | | | 1024 × 1 × 1 | |
| | → Batch normalization | | | | | | | | | |
| | → Convolutional layer | | | | | | | | | |
| | → sum with output of “shortcut” connection⁺⁺⁺ | | | | | | | | | |
| | → PReLU | | | | | | | | | |
| Res (9-11) | Convolutional layer | | 1024 × 3 × 3 | | | 1 | | | 256 × 1 × 1 | |
| | → Batch normalization | {open oversize bracket} | 256 × 3 × 3 | {close oversize bracket} | {open oversize bracket} | 1 | {close oversize bracket} | {open oversize bracket} | 512 × 1 × 1 | {close oversize bracket} |
| | → Convolutional layer | | 512 × 3 × 3 | | | 1 | | | 1024 × 1 × 1 | |
| | → Batch normalization | | | | | | | | | |
| | → Convolutional layer | | | | | | | | | |
| | → sum with output of “shortcut” connection⁺ | | | | | | | | | |
| | → PReLU | | | | | | | | | |
| Conv (3) | Convolutional layer | | 1024 × 1 × 1 | | | 1 | | | 28 | |

*abbreviate for residual blocks⁵.
**PReLU⁷ (Parametric Rectified Linear Unit), with an initial gradient of 0.25.
⁺The output of “shortcut” connection here is the input to the residual block
⁺⁺The output of “shortcut” connection here is result of the input to the residual block going through a 1 × 1 convolutional layer, with a stride of 4.

TABLE 3
Computation Time for compensation with DL-AO

| Number of | | Number of | | |
|---|---|---|---|---|
| frames per | | PSFs for | Estimation | Segmentation |
| mirror update | Tests | estimation | time (ms) | time (ms) |
| 20 | Test 1 | 6 | 55 | 110 |
| 20 | Test 2 | 28 | 76 | 112 |
| 20 | Test 3 | 5 | 52 | 113 |
| 20 | Test 4 | 14 | 63 | 110 |
| 20 | Test 5 | 19 | 66 | 116 |
| 20 | Test 6 | 7 | 66 | 109 |
| 20 | Test 7 | 7 | 61 | 109 |
| 20 | Test 8 | 10 | 56 | 109 |
| 20 | Test 9 | 2 | 64 | 106 |
| 20 | Test 10 | 13 | 50 | 108 |
| 50 | Test 1 | 28 | 81 | 218 |
| 50 | Test 2 | 17 | 64 | 221 |
| 50 | Test 3 | 27 | 70 | 223 |
| 50 | Test 4 | 17 | 56 | 220 |
| 50 | Test 5 | 18 | 57 | 231 |
| 50 | Test 6 | 16 | 60 | 271 |
| 50 | Test 7 | 2 | 40 | 265 |
| 50 | Test 8 | 28 | 74 | 250 |
| 50 | Test 9 | 8 | 57 | 269 |
| 50 | Test 10 | 28 | 70 | 299 |
| 100 | Test 1 | 14 | 64 | 773 |
| 100 | Test 2 | 10 | 65 | 797 |
| 100 | Test 3 | 11 | 76 | 770 |
| 100 | Test 4 | 19 | 62 | 765 |
| 100 | Test 5 | 9 | 59 | 759 |
| 100 | Test 6 | 11 | 63 | 751 |
| 100 | Test 7 | 7 | 53 | 776 |
| 100 | Test 8 | 21 | 61 | 754 |
| 100 | Test 9 | 18 | 76 | 766 |
| 100 | Test 10 | 11 | 65 | 803 |

Note:
1. Computation time was calculated by the difference between two millisecond timers (‘Tick Count (ms)’ function, LabVIEW 2015, National Instruments) before and after performing segmentation/estimation.
2. Estimation time is the total time for: inputting sub-region to neural network (with Python Integration Toolkit for LabVIEW, Enthought Inc.), estimating aberrations with neural network (programed with Python 3.6.5, Anaconda Inc.), and combining network estimations with Kalman filter (programed with LabVIEW 2015, National Instruments).
3. Segmentation time is the total time for biplane registration and segmentation.
4. The aberration estimation was running on a NVIDIA GeForce GTX 1070 graphics card with 8 GB memory. The rest of the computations were performed on an Intel Core i7-5820K processor at 3.30 GHz with 32 GB memory.

TABLE 4
Variation range of parameters in training data generation

| | Range of uniform distributions | | | |
|---|---|---|---|---|
| Parameters | Network1 | Network2 | | Network3 |
| Mirror Mode 1 and 2⁺ | [−1, 1] | [−2, 2] | | [−0.5, 0.5] |
| Mirror Mode 3 and 4 | [−1, 1] | [−1, 1] | | [−0.5, 0.5] |
| Mirror Mode 5 | [−5, 5] | [−1, 1] | | [−0.5, 0.5] |
| Mirror Mode 6-13 | [−1, 1] | [−1, 1] | | [−0.5, 0.5] |
| Mirror Mode 14 | [−20, 20] | [−1, 1] | | [−0.5, 0.5] |
| Mirror Mode 15-28 | [−1, 1] | [−1, 1] | | [−0.5, 0.5] |
| Photon counts per PSF | [1000, 20000] | | counts | |
| Photon counts in detection plane 2 ÷ Photon counts in detection plane 1 | [0.9, 1.5] | | | |
| Background photon counts per detection plane | [1, 300] | | counts | |
| Background photon counts in detection plane 2 ÷ Background photon | [0.9, 1.5] | | | |
| counts in detection plane 1 | | | | |

| | | |
|---|---|---|
| PSF position relative to sub-region center (x and y) | [−3, 3] | pixels** |
| Lateral shift of PSF in detection plane 2 relative to plane 1* | [−1.5, 1.5] | pixels |
| Molecule's axial position relative to focus* | [−2, 2] | μm |
| Axial distance between two detection plane | [0.512, 0.64] | μm |

⁺Mirror mode 1-28 can have different shapes and levels in Wᵣₘₛ for different optical systems. The coefficient values here are the scaling factors for deformable mirror voltage control. They have arbitrary units. Their actual influences can be estimated by linear combining of measured mirror modes then calculating Wᵣₘₛ of the composed wavefront. This estimation is accurate only when mirror deforms linearly with input voltages.
*Focus of biplane setup here is defined as the axial position where the PSFs in two detection planes look most similar.
**pixel size is 119 nm.

### Example 20: Comparison Between DL-AO and Metric-Based AO

### Comparison Between DL-AO and Metric-Based AO in Concept

Wavefront of a single emitter can be measured directly or indirectly if the fluorescent signal is stable and contain enough photon budget. Signals from photo-switchable or photoconvertible dyes in SMLM experiments blink stochastically with limited photons, making it difficult to measure wavefront. Still, wavefront can be obtained when building an in situ PSF model. However, this process requires accumulating thousands of emission patterns, and removing wavefront variations induced by lateral and axial positions of emitters during the iterative phase-retrieving process. Besides, the retrieved pupil phase wraps when wavefront deviation is larger than a wavelength, which cannot be used to feedback the correction element. Due to these difficulties in inferring aberration during SMLM imaging, current sensorless AO methods compensate aberration by iteratively introducing mirror changes then evaluating these changes with image-quality metrics. Though different optimization algorithms have been developed to improve the efficiency and robustness of the compensation, the effectiveness relies on the evaluation criteria, i.e. how to quantify the distortion changes. For conventional fluorescent microscopes, the intensity value can reflect distortion level. However, it cannot be adapted to SMLM due to the intrinsic intensity fluctuations in blinking molecules. Observed that high frequency components are less sensitive to intensity fluctuations, current sensorless AO methods describe the distortion level with a weighted sum of spatial frequency components in a SMLM frame, which is usually called an image-sharpness metric. Different weighting methods are designed to make the metric values respond correctly to distortion changes. Ideally, the metric values should change quadratically with an increasing amplitude of each mirror shape (when we scan large enough range of amplitude), and reach a maximum/minimum when the amplitude corresponds to an optimal compensation.

To test the current state-of-art metric design, we simulated the aberration inferring process. To rule out the sample structure induced variations, we simulated cases where there is only one molecule being detected. When the molecule being detected is right in-focus, we observed that the metric changes quadratically with increasing amplitude, and reaches a maximum value when amplitude is the ground-truth amplitude for optimal compensation (FIGS. 7A-B). However, for the molecule located at 400 nm axially, which is within the commonly captured axial range of SMLM, the ground-truth amplitude corresponds to a minimum metric value, and this minimum value is close to other metric values for amplitude ±2 rad, when scanning the Astigmatism shape. Besides, when scanning the Spherical mode, neither a maximum nor a minimum metric value corresponds to the ground truth amplitude. And similar phenomenon is observed for molecules at 800 nm axial position. These inconsistent, sometimes opposite responses limit the robustness of metric based approaches in SMLM, especially when imaging 3D structures in tissue.

It is difficult to design a feature extractor that summarizes aberration-related information from a SMLM frame, while ignoring irrelevant variations, such as intensity, background, and molecules' positions. Deep neural networks rely on backpropagation16 to turn the first few layers into an appropriate feature extractor, which has been demonstrated to learn the complex relationship from fluorescent beads and single molecule emission patterns to aberration. But the downside of automatic feature extraction is that result can become uncontrollable when irrelevant features are extracted for inference. Therefore, covering the sample space in training dataset is of key importance18. Through a careful characterization of DL-AO performance, we demonstrated that a trained DL-AO network can give estimation to experimental PSFs achieving a 3D normalized cross correlation (NCC) value of >0.95 when comparing measured PSFs with those generated from network estimation (FIG. 8). Feeding back the network estimation to deformable mirror, we demonstrated that DL-AO simultaneously estimates and compensates 28 types of wavefront deformation shapes based on signals from blinking molecules, restores single molecule emission patterns approaching the shapes untouched by sample-induced distortion, and improves the resolution and fidelity of 3D SMLM through thick tissue specimens, with as few as 3-20 mirror changes.

### Comparison Between DL-AO and Metric-Based AO in Practice

For SMLM, the shape of PSF is important for achieving optimal resolution. To compare the capability to restore PSF shapes, we tested DL-AO and current state-of-art metric-based AO, REALM2, on compensating sample induced aberrations based on same area of blinking molecules from immune-fluorescence-labeled Tom20 in COS-7 cells. For sample at coverslip surface, where the aberration is dominated by Coma, both of the methods can restore the PSF shapes. To quantify the restoration, we calculated 3D normalized cross correlation (NCC) between PSFs after AO and the PSFs measured under instrument optimum (Methods). We found that the PSFs after DL-AO is closer to the instrument optimum, with a similarity of 0.964±0.06 (mean±s.t.d, N=6) in NCC, versus a similarity of 0.939±0.031 (mean±s.t.d, N=6) after metric-based AO (FIG. 2C, 2G). For compensating index mismatch induced aberration at 134 μm from coverslip surface, metric-based AO occasionally improved the PSF shapes but sometimes causes extra distortions, while DL-AO can consistently optimize the PSF shapes, achieving a PSF similarity of 0.933±0.012 (mean±s.t.d, N=9). This is because metric-based AO aims at improving the image quality, which is described by improving the high frequency content in an image, however, gaining magnitude in high frequency domain doesn't necessarily mean the 3D PSF is optimized. Since a compensation loop that requires less mirror changes is always preferred to run alongside SMLM imaging, we further compared the number of mirror updates required by DLAO and metric-based AO using simulated SMLM frame. We performed metric-based AO following the optimal setting of REALM: 12 modes, scanning 9 amplitudes from −1 to 1 radian, 3 rounds of compensation. We compared DL-AO and metric-based AO by checking the residual wavefront after each mirror update, when same initial distortion is generated to both methods.

We observed that DL-AO reduces the distortion level to below 0.2 rad in with <5 mirror updates, when estimating from volumetric blinking data (Supplementary FIG. 12). But metric based AO requires >100 updates to achieve the same level, in the case of looking at blinking molecules with no axial distribution. If we test metric-based AO with volumetric data, which is common case for imaging whole cell and tissue, the distortion level barely changed. This is an expected result according to the concepts investigation in previous section, the metric behaves inconsistently for molecules at different axial positions. For imaging a volumetric sample, molecules from different axial planes (usually from −1˜1 μm w.r.t. focus) are detected simultaneously, which would introduce large uncertainties in the corresponding metrics.

### Example 21: Workflow of Deep Learning Driven AO

General Workflow of SMLM Imaging with DL-AO

During SMLM imaging, the blinking data were collected at a laser intensity of 2-6 kW/cm² and a frame rate of 50 Hz, where the first 100-2000 frames were used for DL-AO. Mirror shape is updated based on DL-AO networks' output every 20-100 frames. In the case where significant background photons were observed (about 100 per pixel per frame), a temporal median filter was used to estimate structured background for each pixel, and 100 frames were used to compute this background map. This background map was then subtracted from each camera frame before the frames are segmented into sub-regions for DL-AO processing. After DL-AO correction, 2000 frames were collected per cycle, and 20-120 cycles (50000-236000 frames, Table 1) were collected per imaging area. For the interleaved SMLM imaging without and with AO, deformable mirror shape was set to switch between DL-AO compensated shape and the shape used for instrument optimum (Methods) per imaging cycle (2000 frames). Acquisition of no-AO data was performed first in the interleaved sequence for fair comparison. Upon each switch between no-AO and DL-AO acquisitions, PIFOC objective positioner was moved to compensate apparent focal shift in the case of index mismatch induced aberration. The focal shifts were determined by an estimated linear relationship between the apparent focus shift and the amplitudes of two radially symmetric mirror deformation modes. The shifts per unit amplitude changes were empirically estimated to be −0.3 μm for mirror mode 5 and −0.2 μm for mirror mode 15. Here, a negative movement of PIFOC objective positioner corresponds to shifting the imaging plane closer to the bottom coverslip surface.

### Segmentation Process to Obtain Sub-Regions

Before segmentation, the camera offset, with an estimated value of 100 ADU per pixel were removed from each detected camera frame. In the case where significant background photons were observed (about 100 per pixel per frame), a background map estimated by the temporal median filter was subtracted from each camera frame. Then we removed the camera gain by dividing each pixel value with an estimated gain of 2 ADU/e⁻. The non-positive pixel values in the each processed camera frame are also set to be 1×10⁻⁶. Then each pair of camera frames from two detection planes were sum together, after performing affine transformation to the frames detected on the second plane (‘imwarp’ function with ‘cubic’ interpolation type, MATLAB R2020a, The MathWorks, Inc.) to align the detections from two planes. The transformation matrix was obtained following the previously described method12: We first calculated the maximum intensity projection map of 1000-2000 frames containing single-molecule blinking events for each detection plane. Then we calculated the affine matrix based on these projection images in two planes (‘imregtform’ function, MATLAB R2020a, The MathWorks, Inc.). The same transformation matrix was calculated once and used for different specimen to avoid extra time delay in calculating transformation matrix for each frame.

We then segmented out biplane sub-regions, each of 32×32 pixels, using a segmentation algorithm26. To locate center coordinates of isolated PSFs in SMLM frames, two uniform filters with different kernel sizes (3×3 pixels and 9×9 pixels) were applied to each image, where the image is a summation of two frames from two detection planes. The images filtered with larger kernel size were subtracted from the images filtered with smaller kernel size. Then we applied a maximum filter to the resulting image to locate the pixels containing local maximum intensities. For pixels with local maximum intensities, we considered their positions as candidate sub-region centers if their pixel values are larger than an initial threshold (empirically chosen as 20 photon counts). We then discarded those candidate center coordinates that are closer than 26 pixels to prevent overlapping PSFs in one sub-region. Then we chose center coordinates for cropping sub-regions as the candidate coordinates whose pixel values are larger than a segmentation threshold (empirically chosen as 40-80 photon counts). The center coordinates were used to crop sub-regions out from the first detection plane. For cropping sub-regions in the second detection plane, we transformed coordinates in detection plane 1 to crop the PSF from SMLM frame in detection plane 2.

Aberration Estimation with Deep Neural Network

Pixels in each plane of the bi-plane sub-regions are normalized separately by dividing the maximum pixel value of that plane. Each input sub-region goes through a sequence of template matching processes, which are organized as convolutional layers and residual blocks with PReLU activations and batch normalizations in between, then “fully connects” through 1×1 convolutional layers to an output vector of 28 values—amplitude estimates for wavefront shapes in terms of the native mirror deformation modes.

The neural network resembles the architecture as previously developed single molecule network (smNet) for 21 Zernike coefficients' estimations, with slight modification to accommodate for the input and output size change. The detailed structure of neural network architecture is shown in Table 2. Convolutional layers are used throughout the architecture, as studies have shown that deep neural network architectures with the help of convolutional layers are capable of learning relevant features. Each convolutional kernel slide through the input images or feature maps, outputting a high value when local features have high similarity to the kernels. This process is similar to feature extraction process, and the output of each convolutional process is called a feature map. Except for the first two layers and the final layer connecting to the output, all other convolutional layers are packed into residual blocks6, which add outputs of “shortcut” connections (Supplementary Table 2) to the outputs of the stacked layers. The residual blocks were developed to address common issues in training deep architectures, e.g. overfitting, vanishing/exploding gradient6, and excessive inactive neurons. Due to limited GPU memory and computational resource, it is not practical to update network parameters using the entire training dataset, usually ˜6 million images, at the same time. Instead, a batch of 128 images (empirically chosen) is processed together and the gradient for updating network parameter is the average gradient of the batch. In each iteration, the images are processed batch by batch. The normalization step (Batch Normalization28) is used to normalize the output distribution of each convolutional layer. Activation functions are added to perform non-linear transform in between linear transformations with convolutional layers. We chose PReLU⁷ (Parametric Rectified Linear Unit) as the activation function due to the advantages of no saturation, computational efficient and fast convergence.

Combining Estimation with Kalman Filter
Our initial compensation starts when N₀ sub-regions are segmented. The sub-regions are sent to the trained network, which then output N₀ vectors of 28 mirror mode coefficients. Then we calculated the mean and variance for each mirror mode coefficient among the N₀ estimations. The initial mirror update is applied according to the mean of estimation. Then we measure new SMLM frames under the updated mirror shape, and obtain N₁ sub-regions. After calculating the mean and standard deviation among the N₁ estimations, we update deformable mirror by multiplying the current estimation with a Kalman Gain29 (KG), which is the ratio between variance of the compensation history (till now it is the variance of initial estimation) and the sum of the new variance with history variance. Then the history variance is updated by multiplying with (1−KG). Similarly, future compensations will be new estimations damped by Kalman Gain, and we keep updating history variance after each mirror update. Each compensation starts only when Nᵢ≥2 (for each compensation i=0, 1, 2, . . . ) to make sure there are enough sub-regions for estimating variance. The intuition behind the Kalman filter was to combine noisy measurements that are related, such that the combined prediction become closer to the ground truth in the criterion of mean squared error. Kalman Gain here is a weighting factor between prediction based on previous compensation and a new measurement after previous compensations. When the new measurement has higher variance comparing to the previous compensations, we damp the estimation value based on a variance ratio. The variance of the accumulated compensation will keep decreasing (or keep constant) through combining new measurements. Due to the uncontrollable availability of single molecule emission patterns with high signal-to-background ratio and the evolving PSFs after each correction, we use this process to weigh heavily on high precision measurements against the uncertain ones to ensure stable feedbacks from the network.

### Switching Neural Networks for Estimation

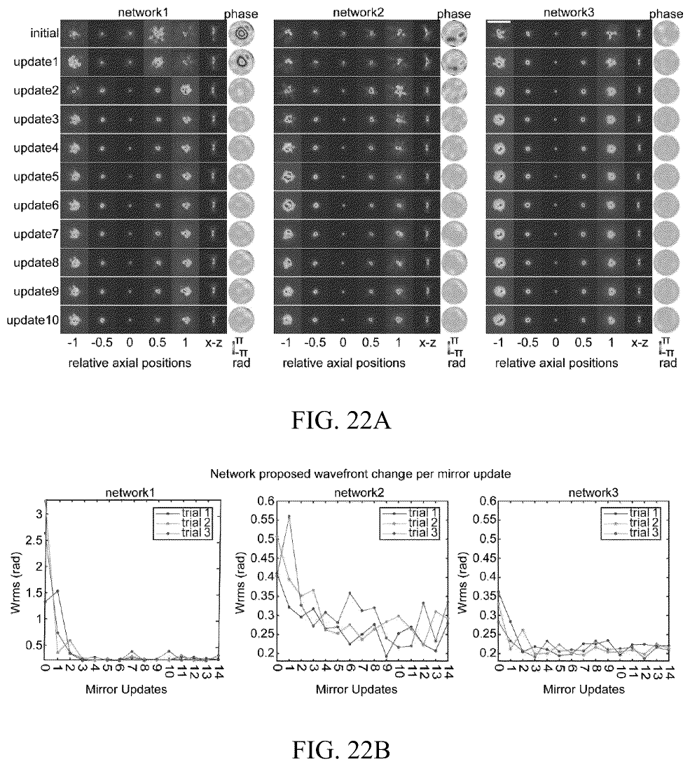

FIGS. 22A-B show trade-off between compensation range and stability with DL-AO. FIG. 22A shows examples of PSFs before and after each mirror update, when compensating artificially induced aberrations with neural network trained from three different ranges. Compensations are performed based on blinking dyes on immune-fluorescence-labeled Tom20 specimen. PSFs are measured from 100-nm-diameter crimson beads nearby the compensation area post SMLM acquisition. Scale bar: 5 μm. ‘phase’ stands for pupil phase obtained by phase retrieval on the measured PSFs from beads. Each PSF was normalized to maximum equals to 1. FIG. 22B shows examples of proposed wavefront change per mirror update, when compensating artificially induced aberrations with neural network trained from three different ranges. ‘Wrms’ stands for root mean square wavefront error (Methods). The training ranges for network are shown in Table 4.

### Reasons of Switching Networks

Compensating wavefront distortions inferred from PSFs of blinking molecules, we found that the network proposed mirror change fluctuates with non-vanishing uncertainty before/after each mirror update. This uncertainty increases with the network training range, resulting in a trade-off between the compensation range and stability (FIGS. 22A-B). To deal with the trade-off between the compensation range and stability, networks trained from three different ranges (Table 4) are switched for each compensation loop. The detailed training parameters for networks 1-3 are shown in Table 4. For network 2, we observed that independent measurements from DL-AO and phase retrieval using PSFs of fluorescent beads resulted in nearly identical wavefront shapes with a small difference of 0.13±0.02 rad (mean±s.t.d, N=28) quantified in root mean square wavefront error3 (Wᵣₘₛ, Methods). Further, comparing the wavefronts estimated by DL-AO network using single molecule blinking data (100 PSFs) to that retrieved by phase retrieval from beads, we observed high similarities of 0.83±0.06 (mean±s.t.d, N=28, normalized cross correlation), and a small wavefront difference of 0.15±0.03 rad (mean±s.t.d, N=28) in Wᵣₘₛ. Using the same dataset as described above, for network 1, which included larger variations for Mirror Mode 5 and Mirror Mode 15, the wavefront similarity decrease to 0.84±0.08 and 0.63±0.19 (mean±s.t.d) in 3D normalized cross correlation (NCC) for beads and cell samples respectively, and wavefront difference increase to 0.17±0.05 and 0.2±0.05 (mean±s.t.d) in Wᵣₘₛ. And for network 3, the wavefront can be estimated with a similarity of 0.83±0.05 and 0.82±0.05 (mean±s.t.d) in Wᵣₘₛ NCC for beads and cells respectively, and wavefront difference of 0.14±0.02 and 0.18±0.03 (mean±s.t.d) in Wᵣₘₛ. We note that the experimental dataset is used for characterizing the three networks, and the wavefront distortions in these experimental PSFs are outside (˜2× larger than) the variation range included in training of network 3.

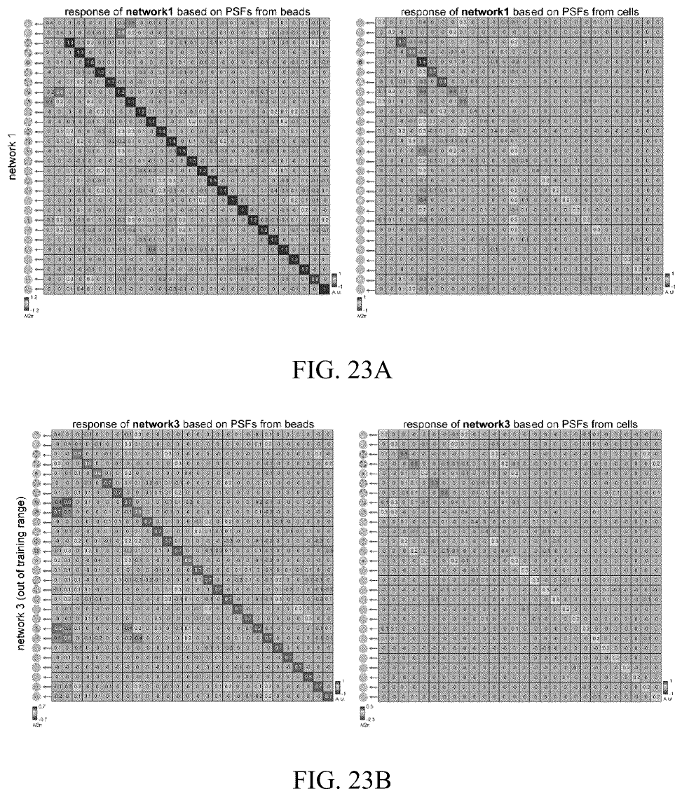

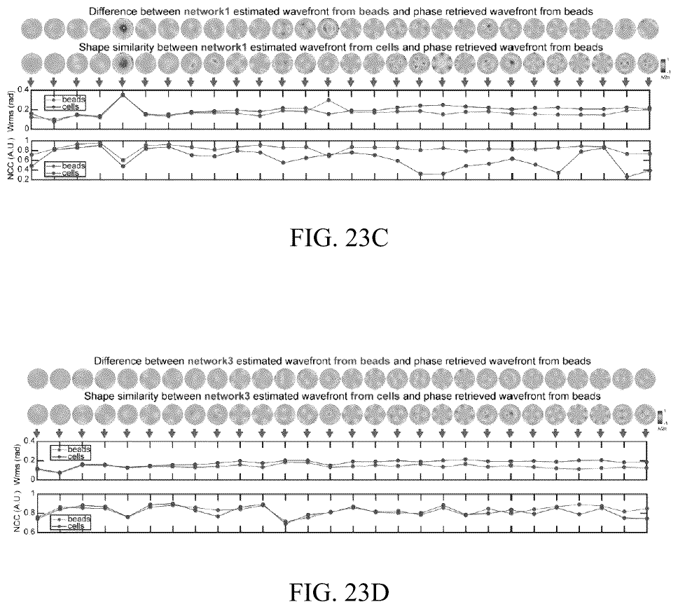

FIGS. 23A-D show characterizing neural network response to mirror mode changes using experimental PSFs. (FIGS. 23A-B) The responses of networks trained from two different ranges, in complement to the characterization for network 2 as shown in above examples. The three training ranges are shown in Table 4. Each row of the response matrix shows the network responded mirror coefficients under a unit change of each mirror deformation mode. After linear combining measured mirror modes with network responded coefficients, we obtained network estimated wavefront shape w.r.t. individual mirror mode changes. The experimental PSFs were obtained from fluorescent beads (31 PSFs imaged when scanning in axial dimension from −1.5 μm to 1.5 μm with a step size of 0.1 μm) and blinking molecules (100 PSFs) from immune-fluorescence-labeled Tom20 specimen. FIGS. 23C-D show pixel-wise differences and shape similarities between network estimated wavefronts and phase retrieved wavefronts, when estimating with network1 and network3 respectively. The top row shows the pixel-wise differences between network estimated wavefront and phase retrieved wavefront using beads. The row below that shows the pixel-wise differences between network estimated wavefront using blinking dyes on Tom20 specimen and phase retrieved wavefront using beads. The plot below that shows the root mean square wavefront error (W_{RMS}, Methods) of each wavefront difference. The plot on the bottom row shows the similarities between network estimated wavefronts and phase retrieved wavefronts, which are quantified with 2D normalized cross correlation (NCC).

### Detailed Process in Switching Networks

The initial compensation starts with estimation from Network 1 (Table 4). By comparing the current estimation variance with two empirically chosen variance-thresholds th1 and th2, we decide whether we will switch to Network 2 or Network 3 respectively. For example, if current estimation variation is larger than th1, the program will use Network1 to continue estimate after the following compensation. With the help of Kalman filter, the history variance will continue decrease and reach below th1 or th2, the program will then switch to Network 2 or Network 3 for the following estimation respectively. Whenever we switch to a different network, we reset history variance to be the first estimation variance of the new network. Kalman filter was not applied to Network 3, due to its small uncertainty observed and the ignorable PSF shape changes caused by its small uncertainty. If the current estimation variance with Network 3 is larger than th1 or th2, the program will switch back to Network1 or Network2 respectively. We either manually stop the compensation after 10-20 compensations, or stop when the wavefront change proposed by Network 3 has a peak-to-valley value smaller than 1/20λ for three consecutive compensations.

### Example 22: Considerations in Mirror Mode Generation

### Reasons of Using Mirror Mode

Training neural network for deformable mirror control requires incorporating accurate wavefront deformations in training data generation. To incorporate these, we can measure the wavefront deformations induced by changes of either individual mirror actuator or several actuators together. However, representing wavefront with coefficients of orthogonal basis helps cut down on the number of outputs and network parameters to be optimized in training. Besides, nonorthogonal basis result in non-unique coefficients for representing the same wavefront, which cause vanishing compensation due to the requirement of averaging coefficients from estimations on different sub-regions. Forming this orthogonal basis directly from native mirror deformations further ensured the coefficients' accuracy in representing mirror responses. With this consideration, the conversion from mirror modes to Zernike polynomials—commonly used as the analytical basis to describe aberrations—is dropped to minimize mismatches between mirror responses and Zernike-based wavefront shapes.

### Mirror Modes Generation Process

Mirror mode generation process follows previously described methods27. In brief, the steps are: (1) simulating actuators' influence functions, i.e. wavefront deformations introduced by poking individual actuators. The simulation is performed by generating a Gaussian blur at the actuator's location, with Gaussian

$$σ = {( - {a}^{2} / 2 log ( 0.2 ) )}^{1 / 2}$$

where “a” represents the distance between nearby actuators' centers. (2) multiplying the wavefront deformation with a binary mask representing 2D shape of pupil in the optical system. (3) calculating the cross-talk between deformations induced by each actuator. (4) generating orthogonal deformation types by linear combining actuators' influence functions. The combination coefficients are found through singular value decomposition of the cross-talk matrix. The final orthogonal deformation types are called mirror modes. The relative actuator voltages for inducing these wavefront deformations in the optical system with deformable mirror are voltage maps of mirror modes.

We observed mismatch between expected wavefront deformations and experimental wavefront deformations, when loading the voltage maps generated in above process to the optical system. The expected wavefront deformations come from mirror mode and voltage map generation process as described above. The experimental wavefront deformations are measured through phase retrieval. Although the expected wavefront deformations are orthogonal with each other, due to the singular value decomposition process, the measured mirror modes are non-orthogonal with each other. We observed that the experimental wavefront deformations look similar to center areas of the expected wavefront deformations, indicating that the expected wavefront deformations were being cut on the boundary in the optical setup. After re-adjusting the relative positions between pupil and mirror actuators, we observed experimental mirror modes become more similar to the expected shapes. Such adjustment makes experimental mirror modes less coupled with each other. This coupling is verified by performing pixel-wise multiplication between a pair of measured mirror modes, where each mirror mode is normalized by dividing its root mean square. The final relationship between pupil and actuators are adjusted based on physical size of mirror actuators, with slight modification based on the measured influence functions. The residual difference between expected and experimental mirror modes is potentially caused by the mismatch between simulated and actual influence function of each actuator. Replacing the simulated actuator influence function with an experimental actual actuator influence function in the system during mirror mode generation is feasible, however, the generated mirror modes are noisy. Therefore, we proceed with this difference and incorporate this into PSF simulation process by using measured mirror modes.

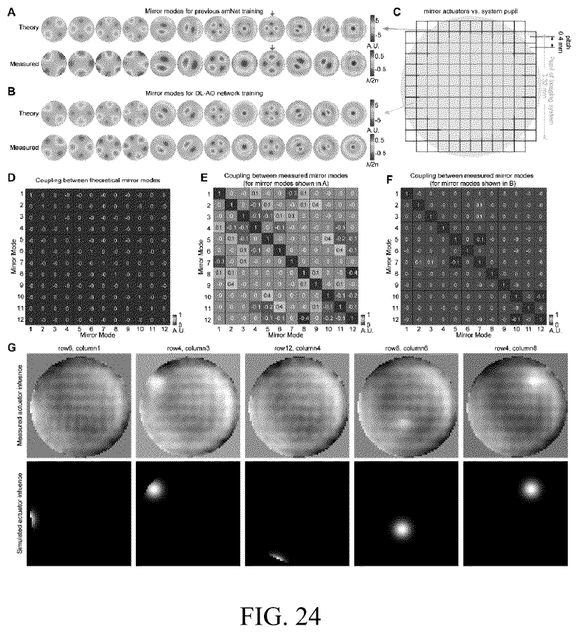

FIG. 24 panels A-G show considerations in mirror mode generation. (Panel A) Comparison between expected wavefront deformation and the measured wavefront deformation when generating mirror mode voltage maps based on relative actuator vs. pupil position shown in grey area in Panel C. These were the mirror modes converted to Zernike polynomials for testing smNet's responses to Zernike modes in previous work. (Panel B) Comparison between expected wavefront deformation and the measured wavefront deformation after updating the relationship of actuator vs. pupil position in Panel C. These are the mirror modes used for DL-AO. (Panel C) Relationship of actuator vs. pupil position used for generating mirror mode voltage maps. (Panels D-F) Coupling between mirror modes. Each entry is the sum of element-wise multiplication between two mirror mode patterns, which are normalized by dividing root mean square of each pattern. The final matrix is further normalized by dividing the maximum of the entire matrix. (Panel G) Comparison between simulated actuator influence functions and those measured through phase retrieval.

### Measurements of Experimental Mirror Modes

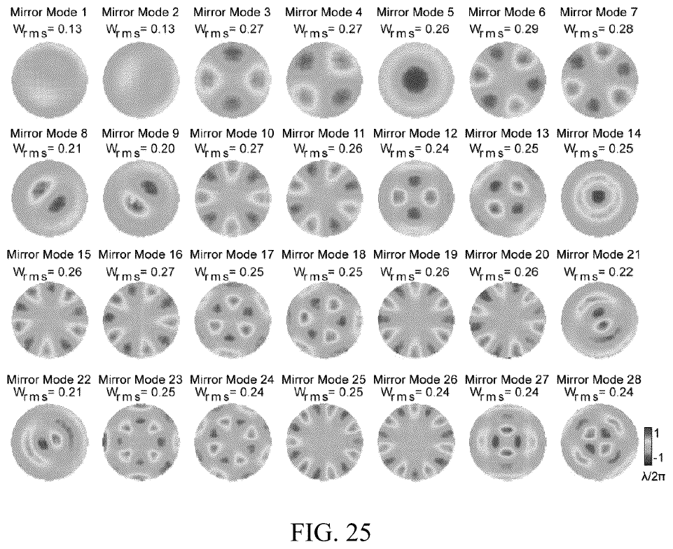

FIG. 25 shows a measured mirror modes in optical setup. The mirror modes were measured with phase retrieval on 100-nm-diameter crimson beads (Methods). Each mirror deformation mode is generated by introducing a unit change in mirror mode voltage control. The level of distortion introduced by each mirror mode is estimated by calculating the root mean square wavefront error (W_{RMS}, Methods) of each phase retrieved wavefront. The unit W_{RMS} of is λ/2π.

The expected mirror deformations simulated from mirror mode generation process have arbitrary unit, which cannot be directly used for generating PSFs. The experimental deformation in optical system needs to be measured. The residual differences between theoretical expectations and experimental mirror deformations (FIG. 25) are incorporated into training data generation. The experimental mirror deformation modes were measured using fluorescent bead sample described above. We introduced a positive and a negative (unit amplitude) mirror changes for each of the 28 mirror deformation modes. For each mirror shape setting, we acquired PSFs at z positions from −1.5 μm to 1.5 μm, with a step size of 100 nm, a frame rate of 10 Hz, and 3 frames per z position. Pupil phase was extracted through phase retrieval algorithm for each mirror change. To obtain the experimental mirror deformation bases without the influences of instrument or sample induced aberrations, we calculated the differences of the retrieved pupil phases between the positive and negative unit changes of mirror mode and divided them by two. The actual distortion level introduced by each unit amplitude change of mirror mode voltage control is quantified through root mean square wavefront error (Methods, FIG. 25).

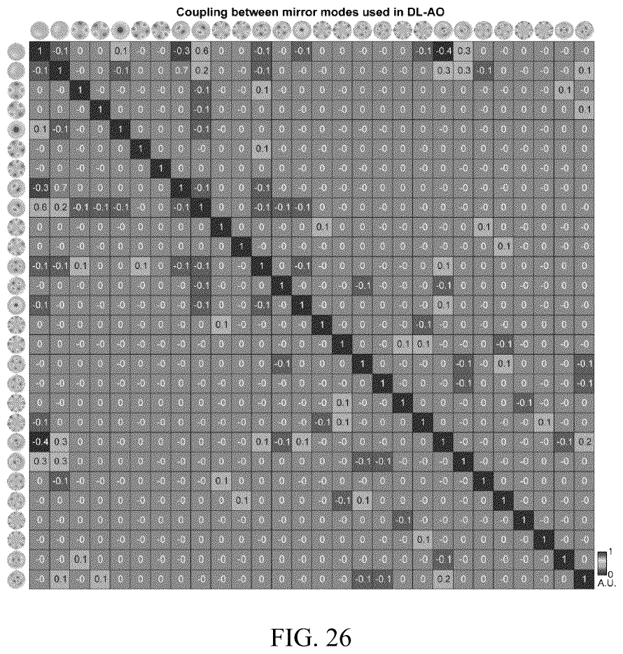

FIG. 26 shows coupling between mirror modes used in DL-AO. Each entry is the sum of element-wise multiplication between two mirror mode patterns, which are divided by root mean square of each pattern to normalize to unit variance. The final matrix is normalized by dividing the maximum of the entire matrix.

### Example 23: Training Data Generation

To build an accurate link between experimentally detected emission patterns and the mirror control with neural networks, it is imperative to train the network with data that match those obtained experimentally. However, experimental training data of single molecules are challenging to obtain, since the ground-truth wavefronts are usually unknown and the extensive variations of the intensity, background and the lateral and axial locations of single emitters, are impractical to cover experimentally. To this end, we simulate PSFs for training neural network. This allows us to efficiently generate millions of training PSFs based on experimentally measured wavefronts with highly accurate training ground truth (normalized cross correlation (NCC) value of >0.95, comparing measured PSFs with those generated from network estimation).

### Measurement of Pupil Functions Under Instrument Optimum

The static residue of system aberration after optimizing the microscope system is also incorporated as the baseline of the wavefront shapes. We measured the wavefront shape under instrument optimum (Methods) with the following steps: (1) collecting a stack of experimental PSFs at z positions from −1.5 to 1.5 μm, with a step size of 100 nm (Methods). (2) preprocessing the data to reduce the noise. (3) obtaining the pupil function through an iterative process based on Gerchberg-Saxton algorithm. Following the same process, we obtained two pupil functions h₁(kₓ, k_{y}) and h₂(kₓ, k_{y}) for the two detection planes. The relative defocus between two pupil functions were removed during phase retrieval process. The phase term contains the best achievable wavefront shape when compensating for sample induced aberrations. The common step of decomposing the obtained wavefront ψ₀ into Zernike polynomials are excluded to avoid residual errors for representing the wavefront after decomposition. We used the Zernike expansion (Wyant ordering) of the pupil function to simulate PSFs at arbitrary positions (x, y, z). Using biplane setup comes with additional benefits: (1) Simultaneous detection at two axial planes provides improved Fisher information24 about wave-front distortion than one detection plane30. (2) The relative small PSF size compared to that of the Astigmatism setup results in increased number of sub-regions containing well-isolated emitters and thus the reliability of real-time aberration measurements.

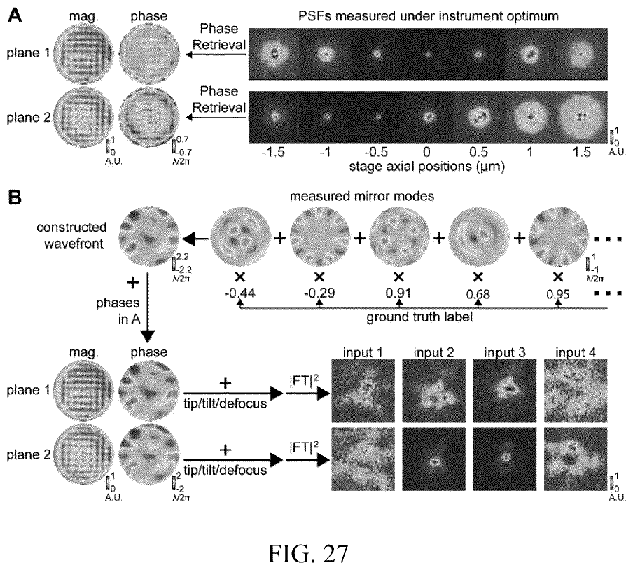

FIG. 27 panels A-B show training data generation. (Panel A) PSFs and pupil functions measured under instrument optimum for two detection planes. (Panel B) Process of simulating aberrated PSFs with constructed wavefront distortion. The tip/tilt/defocus in Zernike Polynomials are added to pupil phase to generate PSFs at different x/y/z positions. The relative focal shift between two detection planes are added by relative defocus difference. FT stands for Fourier Transform of the pupil function. For each wavefront distortion, we can generate various biplane PSFs, the shape variations among which are caused by the variations in molecules' axial positions.

Simulating PSFs with Wavefront Distortions

Each PSF was generated as follows: (1) generating wavefront distortion by linear combining measured mirror modes with coefficients (c₁, c₂, . . . , c₂₈). These coefficients serve as ground truth label for each PSF. (2) generating normalized PSFs for two detection planes, μ₀₁ and μ₀₂, at position (x, y, z):

$${μ}_{01} ( x , y , z , {c}_{1} , {c}_{2} ... , {c}_{28} ) = {\vert {ℱ}^{- 1} [ {h}_{1} ( {k}_{x} , {k}_{y} ) {e}^{i ( {k}_{x} x + {k}_{y} y )} {e}^{{ik}_{z} ( z - \frac{{z}_{d}}{2} )} {e}^{i ( {φ}_{o} + {c}_{1} {φ}_{M 1} + {c}_{2} {φ}_{M 2} + … ++ {c}_{20} {φ}_{M 20} )} ] \vert}^{2} \qquad ( 1 )$$

$${μ}_{02} ( x , y , z , {c}_{1} , {c}_{2} ... , {c}_{28} ) = {\vert {ℱ}^{- 1} [ {h}_{2} ( {k}_{x} , {k}_{y} ) {e}^{i [ {k}_{x} ( x + Δ x ) + {k}_{y} ( y + Δ y ) ]} {e}^{{ik}_{z} ( z + \frac{{z}_{d}}{2} )} {e}^{i ( {φ}_{o} + {c}_{1} {φ}_{M 1} + {c}_{2} {φ}_{M 2} + … ++ {c}_{28} {φ}_{M 28} )} ] \vert}^{2} , \qquad ( 2 )$$

where

$$( {φ}_{M 1} , {φ}_{M 2} ... , {φ}_{M 27} )$$

represent measured mirror modes. The terms

$${e}^{i 2 π {k}_{z} ( z - \frac{{z}_{d}}{2} )} and {e}^{i 2 π {k}_{z} ( z + \frac{{z}_{d}}{2} )}$$

describe the defocus phase, where

$${k}_{z} = {( {( \frac{2 π n}{λ} )}^{2} - {k}_{x}^{2} - {k}_{y}^{2} )}^{1 / 2}$$

is the axial component of the wave vector k and z_{d} represents the axial distance between the two focal planes. (3) multiplying the normalized PSFs with photon count, I, and background count, bg to obtain μ₁ and μ₂.

$${μ}_{1} ( x , y , z , {c}_{1} , {c}_{2} ... , {c}_{28} ) = I {μ}_{01} ( x , y , z , {c}_{1} , {c}_{2} ... , {c}_{28} ) + bg \qquad ( 3 )$$

$${μ}_{2} ( x , y , z , {c}_{1} , {c}_{2} ... , {c}_{28} ) = r \times I {μ}_{02} ( x , y , z , {c}_{1} , {c}_{2} ... , {c}_{28} ) + r \times bg$$

where r represents intensity ratio between two detection planes.

Training a neural network to output the correct mirror mode coefficients while ignoring irrelevant pixel value variations, such as intensity, background, positions shift, is important. This is because we cannot control whether the network learns the correct features relate to the mirror mode coefficients. To avoid irrelevant features being taken into consideration, we generate these aberration-irrelevant parameters from a uniform distribution. The variation range of parameters for generating training dataset are included in Table 4.

### Example 24: Kalman Filter

### General Concept of Kalman Filter

Estimating a parameter based on a single measurement can deviate from the ground truth, as the uncertainty is identical to the standard deviation of measurement noise. Averaging a large number of repeated measurements reduces the estimation uncertainty, however, these repeats are difficult to carry out in practice. One situation is that the parameter is varying in time, e.g. tracking a car's position with GPS. Another case is that successive measurements can have different inaccuracies and uncertainties over time, e.g. weather change can affect the uncertainties of GPS readings. To prevent our estimation from fluctuating wildly before/after incorporating each new measurement, we can constraint our estimation with the knowledge that successive measurements of the same object are highly related with each other, e.g. car's position readings within 10 minutes cannot be larger than 100 miles. Other prior knowledge can come from either a theoretical model or reading from different sensors, e.g. measurement of a car's speed from odometer.

Kalman filter combines noisy measurements from different sources and the uncertain predictions from theoretical models, such that it tends to give an estimate closer to the ground truth than each single measurement/prediction. More specifically, Kalman filter computes a sequential minimum mean squared error (MMSE) estimator that allows us to estimate the parameter at each time point n based on available measurements on and before time n as n increases29. The optimal estimation at time point n is recursively computed by a weighted average between the prediction based on all previous information obtained before time point n and the new measurements obtained at time point n. The weighting factor, named Kalman Gain, is computed based on their uncertainties. Intuitively, this design judges if we should trust more on the new measurements at current time step or on the prediction made based on all previous measurements, according to the uncertainties.

### Kalman Filter Implementation for Deep Learning Driven AO

Here we describe our application of a scalar Kalman filter in computing an upcoming compensation based on all available wavefront measurements pre-/post- each correction. Before applying n^{th} compensation, we describe current ground truth mirror mode coefficient for mirror mode m as with sₘ[n]. We accumulate N[n] sub-regions and send to smNet for wavefront measurement. The measurement for mirror mode m, xₘ[n], is noisy due to the uncertainty of neural network estimation and the uncertainty of deformable mirror mechanical movement. To describe this relationship between noisy measurement and ground truth, we can write an equation for each mirror mode m as follow, which is called an observation equation:

$${x}_{m} [ n ] = {s}_{m} [ n ] + {w}_{m} [ n ] , \qquad ( 4 )$$

where sₘ[n] represent the ground truth value of mirror mode m before n^{th} compensation, wₘ[n] represent the measurement noise for mirror mode m. We assume that wₘ[n] is a Gaussian noise with mean

$$E [ {w}_{m} [ n ] ] = {μ}_{m} [ n ] and variance E [ {w}_{m}^{2} [ n ] ] = {σ}_{m}^{2} [ n ]$$

both changing at different n. We assume that the noise at different n are independent with each other and are uncorrelated with the ground truth sₘ[n]. We also assume that the measurements of different modes are uncorrelated with each other, so that we can use scalar Kalman filter to compute for each mirror mode separately. The standard deviation

σₘ[n]

can be calculated among smNet measurements based on different sub-regions. Instead of estimating sₘ[n] directly with the measurement xₘ[n] (i.e. set them to be equal), which results in an estimation uncertainty same as standard deviation of measurement noise wₘ[n], we estimate sₘ[n] by combining all available measurements

{xₘ[1],xₘ[2], . . . ,xₘ[n]}

to obtain an estimation closer to the ground truth. The criterion of “being closer to the ground truth”

ŝₘ[n|n] closer to the ground truth sₘ[n].

is defined by minimizing the Bayesian MSE:

$$E [ {( {s}_{m} [ n ] - {\hat{s}}_{m} [ n \vert n ] )}^{2} ] \qquad ( 5 )$$

where the expectation is taken with respect to

p(xₘ[1],xₘ[2], . . . ,xₘ[n],sₘ[n]).

The solution, i.e. the optimal minimum mean squared error estimator (MMSE estimator), is the expectation of the posterior distribution:

$${\hat{s}}_{m} [ n \vert n ] = E [ {s}_{m} [ n ] \vert {x}_{m} [ 1 ] , {x}_{m} [ 2 ] , … , {x}_{m} [ n ] ] \qquad ( 6 )$$

To use Kalman filter, the expectation on the right hand side can be simplified as the following equation, assuming the estimator is linear:

$${\hat{s}}_{m} [ n \vert n ] = {\sum }_{k = 1}^{n} {a}_{m , k} {x}_{m} [ k ] \qquad ( 7 )$$

where a_{m,k} are coefficients for linear combining all available measurements.

We then apply our n^{th} compensation by changing the current wavefront shape using deformable mirror. With an ideally behaved deformable mirror, the amount of change is exactly our estimation

ŝₘ[n|n].

Thus, for each mirror mode m, the ground truth value is changed to sₘ[n+1], which can be described by the following equation, commonly referred as the state equation:

$${s}_{m} [ n + 1 ] = {s}_{m} [ n ] - {\hat{s}}_{m} [ n \vert n ] \qquad ( 8 )$$

Since the uncertainty of deformable mirror mechanical movement for each correction is unapproachable, we didn't include it in our state equation.

To restore the coefficients of each mode approaching 0, we need to find an optimal estimate (measured by MMSE),

ŝₘ[n|n]

before each compensation. To find this, we can explicitly solve a_{m,k} in equation (7) for each compensation n. But this requires repeated computations with each new measurement arrives. Kalman filter calculates

$${\hat{s}}_{m} [ n \vert n ] recursively from {\hat{s}}_{m} [ n \vert n - 1 ] ,$$

the prediction of current mirror mode coefficient based on all previous measurements {xₘ[1], xₘ[2], . . . , xₘ[n−1]}:

$${\hat{s}}_{m} [ n \vert n ] = {\hat{s}}_{m} [ n \vert n - 1 ] + {K}_{m} [ n ] ( {x}_{m} [ n ] - {\hat{s}}_{m} [ n \vert n - 1 ] ) \qquad ( 9 )$$

Kₘ[n] is the Kalman Gain, which acts as a weighting factor between new measurements xₘ[n] and prediction based on previous measurements, which is defined as:

$${K}_{m} [ n ] = \frac{{M}_{m} [ n \vert n - 1 ]}{{M}_{m} [ n \vert n - 1 ] + {σ}_{m}^{2} [ n ]} \qquad ( 10 )$$

where the

Mₘ[n|n−1]

represents the Bayesian MSE error of the prediction, i,e, estimating sₘ[n] based on previous data before xₘ[n] is observed, which can be written as following, according to its definition in equation (3):

$${M}_{m} [ n \vert n - 1 ] = E [ {( {s}_{m} [ n ] - {\hat{s}}_{m} [ n \vert n - 1 ] )}^{2} ] = E [ {( {s}_{m} [ n ] )}^{2} ] \qquad ( 11 )$$

According to our state equation (8),

$${s}_{m} [ n ] = {s}_{m} [ n - 1 ] - {\hat{s}}_{m} [ n - 1 \vert n - 1 ] .$$

Thus we can relate the prediction error

Mₘ[n|n−1]

with the estimation error before (n−1)^{th} compensation,

$$M [ n - 1 \vert n - 1 ] ,$$

by:

$${M}_{m} [ n \vert n - 1 ] = E [ {( {s}_{m} [ n - 1 ] - {\hat{s}}_{m} [ n - 1 \vert n - 1 ] )}^{2} ] = M [ n - 1 \vert n - 1 ] \qquad ( 12 )$$

The Bayesian MSE error for n^{th} compensation can be updated recursively based on the error in (n−1)^{th} compensation by:

$${M}_{m} [ n \vert n ] = ( 1 - {K}_{m} [ n ] ) {M}_{m} [ n - 1 \vert n - 1 ] \qquad ( 13 )$$

Intuitively, this process says that when the uncertainty of the new measurement is much larger than the uncertainty of prediction based on previous measurements, we will trust more on the prediction when estimating for the upcoming compensation. Therefore, as n increases, if we can keep obtaining new measurement which has significantly smaller uncertainty comparing to previous measurements, the accumulated Bayesian MSE error will be reduced. Once the error is reduced to be smaller than certain threshold, we will change the current driving network to another network trained with smaller range.

For the initial condition at n=1, we define kₘ[1]=[1] and Mₘ[1][1]. According to our definition in equation (8), we assumed that the deformable mirror is behaving ideally, therefore, the prediction based on our previous measurements will be 0, i.e.

$${\hat{s}}_{m} [ n \vert n - 1 ] = 0.$$

Thus, equation (9) for combining prediction and new measurement can be simplified as:

$${\hat{s}}_{m} [ n \vert n ] = {K}_{m} [ n ] {x}_{m} [ n ] \qquad ( 14 )$$

### Example 25: PSFs and Pupil Functions Used for Characterizing DL-AO Performance

### PSF Measurements for In Vitro PSF Models

To construct samples with fluorescent beads nearby immune-fluorescence-labeled cells, we diluted 100-nm-diameter crimson beads (custom-designed, Invitrogen) to 1:1,000,000 in deionized water. Then 500 μL of poly-l-lysine solution (P4707, Sigma-Aldrich) was added to the coverslip with immune-fluorescence-labeled cells, incubated for 20 min and subsequently rinsed with deionized water (pipette gently to avoid washing out cells). We added 1 mL of the diluted bead solution to the coverslip, which was incubated for 20 min at room temperature (RT). Immediately before SMLM imaging, the coverslip without or with specimens attached was placed on a custom-made holder for imaging cells away from or at the bottom coverslip surface respectively. And imaging buffer (10% (wt/vol) glucose in 50 mM Tris, 50 mM NaCl, 10 mM MEA, 50 mM BME, 2 mM COT, 2.5 mM PCA and 50 nM PCD, pH 8.0) was added on top of the bottom coverslip. Then another coverslip with or without specimens was placed on top of the imaging buffer for imaging cells away from or at the bottom coverslip surface respectively. This coverslip sandwich was sealed with two-component silicone dental glue. To control the distance between specimens and bottom coverslip, we used following steps: 200 μL of poly-l-lysine solution was added to cleaned coverslip on bottom, incubated for 20 min and subsequently rinsed with deionized water. Then 20 μL of microsphere suspension (134 μm diameter, 7640A, Thermo Scientific) was spread around the outer ring area of the coverslip, and incubated at RT until the coverslip was dried. Then we placed this coverslip with microspheres at the bottom and added the coverslip with cells on top of it, with the cell-side surface facing down.

After finishing DL-AO compensation on a cell area, we moved manual stage (Manual MicroStage-LT, Mad City Labs Inc.) in lateral dimension to search for area containing fluorescent beads. An area with one isolated bead, i.e. with no other fluorescent structures within its neighborhood of 60 pixels×60 pixels, was chosen to measure the 3D PSF stack. The axial position of the bead was adjusted to be approximately in focus in the one detection plane. The PSFs were acquired at a series of z positions from −1.5 μm to 1.5 μm, with a step size of 100 nm, and 3 frames per z position, where z positions are moved by the PIFOC objective positioner (ND72Z2LAQ, Physik Instrumente). The frame rate was chosen from 5-10 Hz and laser power was ˜50 W/cm2. Both frame rate and laser power needs to be adjusted accordingly, such that the PSFs at ±1.5 μm contrast against background and the highest pixel value among the stack doesn't saturate the camera. To acquired 3D PSF stack without DL-AO compensation, we reset deformable mirror the shape as the one obtained for instrument optimum (Methods), and following the measurement process as described above. Only one detection plane is used for comparing PSFs without and with DL-AO.

### In Vitro PSF Models and Pupil Functions

### Phase Retrieval Process

To obtain the pupil function, which describes how wavefront from a single molecule is affected upon transmission through specimen and imaging system, we performed phase retrieval algorithm on the PSFs measured without and with DL-AO. Multiple phase retrieval methods have been developed for SMLM10,11,31,32. In this work, we chose a phase retrieval method10 based on Gerchberg-Saxon algorithm9,33,34, which is an iterative process of retrieval the pupil function from a series of PSFs with various amounts of known defocus.

Before performing phase retrieval, the following process was used to preprocess the measured PSFs, which is modified from previous developed method. First, we cropped out an area of 50×50 pixels in each acquired camera frame. We then computed an average of the 3 frames acquired at each z position. The camera offset, with an estimated value of 100 ADU per pixel were removed from each detected camera frame. Then we removed the camera gain by dividing each pixel value with an estimated gain of 2 ADU/e⁻. The non-positive pixel values in the each processed camera frame are also set to be 1×10⁻⁴. The PSF stack is first shifted to its center laterally, with the lateral shift relative to the center of the cropped region estimated by fitting a 2D Gaussian to the most in-focus PSF. Then the background is subtracted from each frame, with background estimated from the minimum of four values, each represent the mean value of the pixels at the four edges of the corresponding cropped image. Following that, a circular mask with diameter of 50 pixels are multiplied to the resulting image to set pixel values outside the mask to be zero. The negative pixel values in the resulting image are also set to be zero. Then the images sizes are restored to 128×128 pixels by padding zeros on the boundaries. Following that, each image is normalized to sum to 1.

Our parameters used for performing phase retrieval are: numerical aperture of the objective lens NA=1.35, the emission wavelength λ=680 nm, the refractive index of the objective immersion medium n=1.406, the refractive index of the sample medium n=1.35 or 1.406 (measured by Abbe refractometer, 334610, Thermo Scientific) and the effective pixel size of 119 nm on the sample plane. Phase retrieval algorithm was performed on eight PSFs selected from the measured PSF stacks (−1.5 μm, −1.1 μm, −0.7 μm, −0.3 μm, 0.1 μm, 0.5 μm, 0.9 μm, 1.3 μm).

For PSF at each axial position, an initial empty pupil was set to start phase retrieval. A defocus phase computed from the expected axial distance to the approximated focus was added to the pupil phase. After performing Fourier transform of the composed pupil, we replaced the magnitude of the resulting image with the square root of the measured PSF. Following an inverse Fourier transform, we updated our pupil function. The defocus phase added before transform was removed from the resulting pupil to estimate the system pupil. Pupil functions computed from all eight PSFs were averaged to complete the first iteration. And the averaged pupil function will be the initial pupil function for the next iteration. The above process was repeated for 25 iterations to complete the initial phase retrieval process. From the resulting pupil, we estimated the tip, tilt and defocus phase and removed them from the pupil phase to re-center the PSF stack. Subsequently, phase retrieval algorithm was performed again on the measured PSF stack with the updated lateral and axial positions, then a radial modification of the magnitude components of the pupil function was performed on the phase retrieved PSF model to account for the difference between measured PSF and phase retrieved PSF model. The final pupil function is obtained with 10 repeats of re-centering PSF stack, performing phase retrieval to the PSF stack, and modifying the magnitude component of the pupil function.

### In Vitro PSF Models and Pupil Functions

We constructed three different in vitro PSF models and pupil functions for comparing SMLM reconstruction without and with AO. The first one is in vitro PSF model and pupil function from bottom beads under instrument optimum, which is used in ‘DL-AO+PR’ certain figures herein. This is obtained by performing phase retrieval on the PSF stacks measured under instrument optimum. The second one is in vitro PSF model and pupil function with index mismatched aberration, which is used in ‘no AO+PR’ in certain figures herein. This is obtained by performing phase retrieval on the PSF stacks measured next to the compensation area. The third one is in vitro PSF model with theoretical index mismatch aberration, which is used in ‘no AO+PR’ in in certain figures herein. This is obtained by adding a theoretically derived index mismatch induced aberration phase to the pupil function measured under instrument optimum.

### In Situ PSF Models and Pupil Functions

We constructed in situ PSF models and pupil functions for each compensation area for SMLM reconstruction without and with AO. The models were obtained by performing in situ phase retrieval on the blinking dataset measured for SMLM reconstruction, with INSPR software12. For segmentation process, we set the sub-region size to 32×32 pixels, initial intensity threshold to 25, segmentation threshold to 40, distance threshold to 26. And we accumulated at least 3000 PSFs for INSPR model generation. We set similarity threshold to 0.5, and group threshold to 30 during INSPR model generation.

What is claimed is:

1. A system comprising:
an imaging apparatus configured for conducting single-molecule localization microscopy (SMLM), wherein the imaging apparatus comprises a deformable mirror and a dynamic filter; and
a processor operably associated with the imaging apparatus and configured to:
monitor individual emission patterns produced via the imaging apparatus from a plurality of different single molecules in a sample;
infer shared wavefront distortion for each of the individual emission patterns;
provide the shared wavefront distortion for each of the individual emission patterns through the dynamic filter; and
operate the deformable mirror to compensate for sample induced aberrations.

2. The system of claim 1, wherein the processor simultaneously estimates and compensates for 28 types of wavefront deformation shapes.

3. The system of claim 1, wherein the processor restores single molecule emission patterns approaching pre-analysis conditions.

4. The system of claim 1, wherein the processor improves resolution and fidelity of three dimensional SMLM through tissue specimens over 130 micrometers.

5. The system of claim 4, wherein the improvement is accomplished in as few as 3-20 mirror changes.

6. The system of claim 1, wherein the processor is trained via a training data set, wherein the training data set that comprises segmenting single molecule-containing sub-regions.

7. The system of claim 6, wherein each sub-region goes through a sequence of template matching processes, which are organized as convolutional layers and residual blocks with PReLU activations and batch normalizations in between.

8. The system of claim 7, wherein the processor then fully connects through 1×1 convolutional layers to an output vector of values amplitude estimates for wavefront shapes in terms of the native mirror deformation modes.

9. The system of claim 8, wherein the wavefront is represented with coefficients of orthogonal basis.

10. The system of claim 1, wherein the dynamic filter is a Kalman filter.

11. A method for improving single-molecule localization microscopy (SMLM), the method comprising:
monitor, via a processor operably associated with an imaging apparatus configured for conducting single-molecule localization microscopy (SMLM), individual emission patterns produced via the imaging apparatus from a plurality of different single molecules in a sample;
inferring, via the processor, shared wavefront distortion for each of the individual emission patterns;
providing, via the processor, the shared wavefront distortion for each of the individual emission patterns through a dynamic filter of the imaging apparatus; and
operating, via the processor, a deformable mirror of the imaging apparatus to compensate for sample induced aberrations, thereby improving SMLM.

12. The method of claim 11, wherein the processor simultaneously estimates and compensates for 28 types of wavefront deformation shapes.

13. The method of claim 11, wherein the processor restores single molecule emission patterns approaching pre-analysis conditions.

14. The method of claim 11, wherein the processor improves resolution and fidelity of three dimensional SMLM through tissue specimens over 130 micrometers.

15. The method of claim 14, wherein the improvement is accomplished in as few as 3-20 mirror changes.

16. The method of claim 11, wherein the processor is trained via a training data set, wherein the training data set that comprises segmenting single molecule-containing sub-regions.

17. The method of claim 16, wherein each sub-region goes through a sequence of template matching processes, which are organized as convolutional layers and residual blocks with PReLU activations and batch normalizations in between.

18. The method of claim 17, wherein the processor then fully connects through 1×1 convolutional layers to an output vector of values amplitude estimates for wavefront shapes in terms of the native mirror deformation modes.

19. The method of claim 18, wherein the wavefront is represented with coefficients of orthogonal basis.

20. The method of claim 11, wherein the dynamic filter is a Kalman filter.
